(19) United States
(12) Patent Application Publication
(10) Pub. No.: US 2024/0319623 A1
(43) Pub. Date: Sep. 26, 2024

(54) ELECTROSTATIC IMAGE DEVELOPING TONER, ELECTROSTATIC IMAGE DEVELOPER, TONER CARTRIDGE, AND IMAGE FORMING APPARATUS

(71) Applicant: FUJIFILM Business Innovation Corp., Tokyo (JP)

(72) Inventors: Daisuke ISHIZUKA, Kanagawa (JP); Tsutomu FURUTA, Kanagawa (JP); Erina SAITO, Kanagawa (JP); Tomohito NAKAJIMA, Kanagawa (JP)

(73) Assignee: FUJIFILM Business Innovation Corp., Tokyo (JP)

(21) Appl. No.: 18/456,089

(22) Filed: Aug. 25, 2023

(30) Foreign Application Priority Data
Mar. 24, 2023 (JP) 2023-048934

(51) Int. Cl. G03G 9/087; G03G 9/08; G03G 15/08; G03G 15/16

(52) U.S. Cl. CPC G03G 9/08755; G03G 9/0823; G03G 15/0865; G03G 15/1635; G03G 2215/0607

(57) ABSTRACT

An electrostatic image developing toner includes a binder resin; and resin particles, the binder resin including an amorphous resin and a crystalline resin, the resin particles including a styrene-(meth)acrylate copolymer. When a glass transition temperature calculated using a Fox equation on the basis of proportions of monomers constituting the entire resin particles is defined as Tg(C1°) C and a glass transition temperature measured using a differential scanning calorimeter is defined as Tg(E)° C., 5.0≤Tg(E)−Tg(C1)≤20.0, and when a glass transition temperature calculated using a Fox equation on the basis of monomer proportions determined by surface analysis of the resin particles is defined as Tg(C2)° C., Tg(C1)<Tg(C2).

### CROSS-REFERENCE TO RELATED APPLICATIONS

This application is based on and claims priority under 35 USC 119 from Japanese Patent Application No. 2023-048934 filed Mar. 24, 2023.

### BACKGROUND

### (i) Technical Field

The present disclosure relates to an electrostatic image developing toner, an electrostatic image developer, a toner cartridge, and an image forming apparatus.

### (ii) Related Art

Japanese Unexamined Patent Application Publication No. 2011-34013 discloses a toner that includes a binder resin having a first functional group, organic microparticles having a second functional group present on the surfaces, and a colorant, wherein the first and second functional groups are crosslinked with each other, the organic microparticles have a crosslinked structure formed as a result of resins constituting the organic microparticles crosslinking with one another, and the designed glass transition temperature is 20° C. or less.

Japanese Unexamined Patent Application Publication No. 2021-189408 discloses an electrostatic image developing toner that includes toner matrix particles including at least a binder resin, wherein the toner matrix particles are formed as a result of aggregation and fusion of microparticles of the binder resin and seeded-polymerized microparticles, each of the seeded-polymerized microparticles has a shell and a seed portion, the difference (Tg2−Tg1) between the glass transition temperature Tg1 of the seed portion and the glass transition temperature Tg2 of the shell is 50° C. or more, the binder resin includes an amorphous resin having a glass transition temperature Tgm as a principal component, and the Tgm is higher than Tg1.

### SUMMARY

It is known that the low temperature fixability of a toner can be enhanced by adding a crystalline resin to the toner. In the case where a toner including a large amount of crystalline resin is used, when images are stacked on top of one another after the fixing step has been finished and before the sheet temperature is reduced, the images may adhere to one another to cause image defects. Although a technique in which an additive such as resin particles is added to the inside of toner particles is also known, it has been difficult to reduce the adhesion of images, such as offset, and achieve low temperature fixability simultaneously.

Aspects of non-limiting embodiments of the present disclosure relate to a toner that may reduce the adhesion of images to one another and has low temperature fixability simultaneously, compared with a toner including resin particles wherein a component derived from a styrene monomer is not localized in the surfaces of the particles.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrostatic image developing toner including a binder resin and resin particles, the binder resin including an amorphous resin and a crystalline resin, the resin particles including a styrene-(meth)acrylate copolymer, wherein, when a glass transition temperature calculated using a Fox equation on the basis of proportions of monomers constituting the entire resin particles is defined as Tg(C1)° C. and a glass transition temperature measured using a differential scanning calorimeter is defined as Tg(E)° C., 5.0≤Tg(E)−Tg(C1)≤20.0 and, when a glass transition temperature calculated using a Fox equation on the basis of monomer proportions determined by surface analysis of the resin particles is defined as Tg(C2)° C., Tg(C1)<Tg(C2).

### BRIEF DESCRIPTION OF THE DRAWINGS

Exemplary embodiments of the present disclosure will be described in detail based on the following figures, wherein:

FIG. 1 is a schematic diagram illustrating an example of an image forming apparatus according to an exemplary embodiment; and

FIG. 2 is a schematic diagram illustrating an example of a process cartridge detachably attachable to the image forming apparatus according to the exemplary embodiment.

### DETAILED DESCRIPTION

Exemplary embodiments of the present disclosure are described below. It should be noted that the following description, Examples, etc. are intended to be illustrative of the exemplary embodiments but not restrictive of the scope of the present disclosure.

In the present disclosure, the expressions “X or more and Y or less” and “X to Y” used for describing a numerical range mean the numerical range that includes the lower and upper limits unless otherwise specified. In the present disclosure, in the case where a composition includes a plurality of types of substances that correspond to a component of the composition, the content of the component in the composition is the total content of the substances in the composition unless otherwise specified.

In the present disclosure, “electrostatic image developing toner” may be referred to simply as “toner”, “electrostatic image developing carrier” may be referred to simply as “carrier”, and “electrostatic image developer” may be referred to simply as “developer”.

In the present disclosure, the term “(meth)acryl” refers to both “acryl” and “methacryl”.

### Electrostatic Image Developing Toner

An electrostatic image developing toner according to this exemplary embodiment is an electrostatic image developing toner including a binder resin and resin particles. The binder resin includes an amorphous resin and a crystalline resin. The resin particles include a styrene-(meth)acrylate copolymer. When the glass transition temperature calculated using a Fox equation on the basis of the proportions of monomers constituting the entire resin particles is defined as Tg(C1)° C. and the glass transition temperature measured using a differential scanning calorimeter is defined as Tg(E)° C., 5.0≤Tg(E)−Tg(C1)≤20.0. Furthermore, when the glass transition temperature calculated using a Fox equation on the basis of the monomer proportions determined by surface analysis of the resin particles is defined as Tg(C2)° C., Tg(C1)<Tg(C2).

It is known that low temperature fixation can be achieved by adding a crystalline resin to a toner. In the case where a toner including a large amount of crystalline resin is used, when images are stacked on top of one another after the fixing step has been finished and before the sheet temperature is reduced, the images may adhere to one another to cause image defects.

Although a technique in which an additive such as resin particles is added to the inside of toner particles is also known, it has been difficult to reduce the adhesion of images to one another and achieve low temperature fixability simultaneously.

Since the toner according to this exemplary embodiment has the above-described structure, a reduction in the adhesion of images to one another and low temperature fixability may be both achieved. The mechanisms are presumably as described below.

In this exemplary embodiment, it is considered that the above-described features may be both achieved when the following conditions are satisfied simultaneously: (1) upon the fixation of the toner, resin particles are exposed at the surfaces of images, and (2) a continuous compositional gradient is present in the resin particles.

As for (1), arranging resin particles having certain elasticity to expose at the surfaces of images reduces the likelihood of the images adhering to one another. The above structure may be achieved by, for example, reducing the affinity between the binder resin and the resin particles or crosslinking the resin particles having certain elasticity to reduce the likelihood of the resin particles permeating paper sheets. However, in the case where resin particles are simply added to the toner, the resin particles behave elastically and does not become deformed upon the application of thermal pressure during fixation. This may degrade low temperature fixability.

In contrast, in the case where the compositional gradient as described in (2) is present, it is considered that the resin particles behave elastically when the pressure is low, while being susceptible to plastic deformation when the pressure is high. Specifically, when images are stacked on top of one another, the pressure is low, the toner behaves elastically, and the adhesion may be reduced consequently. On the other hand, when images are fixed at high pressures, the toner behaves plastically and, consequently, a reduction in the adhesion of images to one another and the low temperature fixation may be both achieved.

In this exemplary embodiment, the difference between the glass transition temperature of the resin particles which is determined using the Fox equation and the measured glass transition temperature of the resin particles means that styrene monomers and (meth)acrylate monomers are not randomly bonded to each other and a sequence composed primarily of styrene and a sequence composed primarily of (meth)acrylate are present in a mixed manner. For example, adjusting the polymerization mode enables the glass transition temperature of the surfaces of the resin particles to be relatively high in terms of composition and causes localization of styrene. Consequently, a continuous compositional gradient may be formed in the resin. It is considered that localizing a unit derived from a styrene monomer at the surfaces reduces the affinity for the binder resin and creating the compositional gradient enables the resin particles to behave plastically under a high-temperature, high-pressure condition.

As described above, it is considered that both reduction in the adhesion of images to one another and low temperature fixability may be achieved when the above conditions (1) and (2) are both satisfied.

Details of the electrostatic image developing toner according to this exemplary embodiment are described below.

The electrostatic image developing toner according to this exemplary embodiment includes a binder resin and resin particles. The toner particles include, for example, a binder resin, resin particles, and, as needed, a colorant, a release agent, and other additives.

### Binder Resin

Examples of the binder resin include vinyl resins that are homopolymers of the following monomers or copolymers of two or more monomers selected from the following monomers: styrenes, such as styrene, para-chlorostyrene, and α-methylstyrene; (meth)acrylates, such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; ethylenically unsaturated nitriles, such as acrylonitrile and methacrylonitrile; vinyl ethers, such as vinyl methyl ether and vinyl isobutyl ether; vinyl ketones, such as vinyl methyl ketone, vinyl ethyl ketone, and vinyl isopropenyl ketone; and olefins, such as ethylene, propylene, and butadiene.

Examples of the binder resin further include non-vinyl resins, such as epoxy resins, polyester resins, polyurethane resins, polyamide resins, cellulose resins, polyether resins, and modified rosins; a mixture of the non-vinyl resin and the vinyl resin; and a graft polymer produced by polymerization of the vinyl monomer in the presence of the non-vinyl resin.

The above binder resins may be used alone or in combination of two or more.

The binder resin preferably includes a polyester resin.

In the case where the binder resin includes a polyester resin, when a styrene-(meth)acrylate copolymer is used as resin particles as described below, the affinity between the binder resin and the resin particles is enhanced and, consequently, degradation of the dispersibility of the resin particles may be limited.

The binder resin includes an amorphous resin and a crystalline resin.

The term “amorphous resin” used herein refers to a resin that does not exhibit a distinct endothermic peak but only a step-like endothermic change in thermal analysis conducted using differential scanning calorimetry (DSC), that is solid at normal temperature, and that undergoes heat plasticization at a temperature equal to or higher than the glass transition temperature.

The term “crystalline resin” used herein refers to a resin that exhibits a distinct endothermic peak instead of a step-like endothermic change in DSC, that is, for example, a resin that exhibits an endothermic peak with a half-width of 10° C. or less at a heating rate of 10° C./min.

The amorphous resin is described below.

Examples of the amorphous resin include the amorphous resins known in the related art, such as an amorphous polyester resin, an amorphous vinyl resin (e.g., a styrene acrylic resin), an epoxy resin, a polycarbonate resin, and a polyurethane resin. Among the above amorphous resins, an amorphous polyester resin and an amorphous vinyl resin (in particular, a styrene acrylic resin) are preferable, and an amorphous polyester resin is more preferable.

### Amorphous Polyester Resin

Examples of the amorphous polyester resin include condensation polymers of a polyvalent carboxylic acid and a polyhydric alcohol. The amorphous polyester resin may be a commercially available one or a synthesized one.

Examples of the polyvalent carboxylic acid include aliphatic dicarboxylic acids, such as oxalic acid, malonic acid, maleic acid, fumaric acid, citraconic acid, itaconic acid, glutaconic acid, succinic acid, alkenyl succinic acid, adipic acid, and sebacic acid; alicyclic dicarboxylic acids, such as cyclohexanedicarboxylic acid; aromatic dicarboxylic acids, such as terephthalic acid, isophthalic acid, phthalic acid, and naphthalenedicarboxylic acid; anhydrides of these dicarboxylic acids; and lower (e.g., 1 to 5 carbon atoms) alkyl esters of these dicarboxylic acids. Among these polyvalent carboxylic acids, aliphatic dicarboxylic acids may be used in order to control the affinity between the binder resin and the resin particles. In the case where an aliphatic dicarboxylic acid is used, the proportion of units derived from the aliphatic dicarboxylic acid to units derived from acid component monomers included in the amorphous polyester resin is preferably 2 mol % or more and 20 mol % or less and is further preferably 3 mol % or more and 15 mol % or less.

In the case where two or more types of amorphous polyester resins are used in combination, it is preferable that the content of units derived from isophthalic acid is 10 mol % or more and 50 mol % or more in terms of weighted average.

Trivalent or higher carboxylic acids having a crosslinked structure or a branched structure may be used as a polyvalent carboxylic acid in combination with the dicarboxylic acids. Examples of the trivalent or higher carboxylic acids include trimellitic acid, pyromellitic acid, anhydrides of these carboxylic acids, and lower (e.g., 1 to 5 carbon atoms) alkyl esters of these carboxylic acids.

The above polyvalent carboxylic acids may be used alone or in combination of two or more.

Examples of the polyhydric alcohol include aliphatic diols, such as ethylene glycol, diethylene glycol, triethylene glycol, propylene glycol, butanediol, hexanediol, and neopentyl glycol; alicyclic diols, such as cyclohexanediol, cyclohexanedimethanol, and hydrogenated bisphenol A; and aromatic diols, such as bisphenol A-ethylene oxide adduct and bisphenol A-propylene oxide adduct. Among these polyhydric alcohols, for example, aromatic diols and alicyclic diols may be used. In particular, aromatic diols may be used.

Trihydric or higher alcohols having a crosslinked structure or a branched structure may be used as a polyhydric alcohol in combination with the diols. Examples of the trihydric or higher alcohols include glycerin, trimethylolpropane, and pentaerythritol.

The above polyhydric alcohols may be used alone or in combination of two or more.

The acid value of the amorphous polyester resin is preferably 5 mgKOH/g or more and 20 mgKOH/g or less and is further preferably 7 mgKOH/g or more and 16 mgKOH/g or less in order to control the affinity between the binder resin and the resin particles.

The acid value of the amorphous polyester resin is measured in the following manner.

The toner that is to be measured is dissolved in tetrahydrofuran (THF) to remove the insoluble component. Subsequently, the amorphous polyester resin is separated. Using the separated amorphous polyester resin, the acid value of the resin is measured in accordance with the method (neutralization titration) defined by JIS K0070-1992.

Note that acid value is the milligrams of potassium hydroxide required to neutralize acidic groups (e.g., carboxyl groups) included in 1 g of a sample.

The glass transition temperature Tg of the amorphous polyester resin is preferably 50° C. or more and 80° C. or less and is more preferably 50° C. or more and 70° C. or less.

The glass transition temperature of the amorphous polyester resin is determined from a differential scanning calorimetry (DSC) curve obtained by DSC. More specifically, the glass transition temperature of the amorphous polyester resin is determined from the “extrapolated glass-transition-starting temperature” according to a method for determining glass transition temperature which is described in JIS K 7121:1987 “Testing Methods for Transition Temperatures of Plastics”. The method for determining the measured glass transition temperatures of the other resins is the same as described above. In the measurement of the glass transition temperature of the amorphous polyester resin, the glass transition temperature of the amorphous polyester resin obtained by melt separation performed in the method described in the measurement of acid value is measured.

The weight average molecular weight Mw of the amorphous polyester resin is preferably 5,000 or more and 1,000,000 or less and is more preferably 7,000 or more and 500,000 or less.

The number average molecular weight Mn of the amorphous polyester resin may be 2,000 or more and 100,000 or less.

The molecular weight distribution index Mw/Mn of the amorphous polyester resin is preferably 1.5 or more and 100 or less and is more preferably 2 or more and 60 or less.

The weight average molecular weight and number average molecular weight of the amorphous polyester resin are determined by gel permeation chromatography (GPC). Specifically, the molecular weights of the amorphous polyester resin are determined by GPC using a “HLC-8120GPC” produced by Tosoh Corporation as measuring equipment, a column “TSKgel SuperHM-M (15 cm)” produced by Tosoh Corporation, and a THF solvent. The weight average molecular weight and number average molecular weight of the amorphous polyester resin are determined on the basis of the results of the measurement using a molecular-weight calibration curve based on monodisperse polystyrene standard samples.

The amorphous polyester resin may be produced by any suitable production method known in the related art. Specifically, the amorphous polyester resin may be produced by, for example, a method in which polymerization is performed at 180° C. or more and 230° C. or less, the pressure inside the reaction system is reduced as needed, and water and alcohols that are generated by condensation are removed.

In the case where the raw materials, that is, the monomers, are not dissolved in or miscible with each other at the reaction temperature, a solvent having a high boiling point may be used as a dissolution adjuvant in order to dissolve the raw materials. In such a case, the condensation polymerization reaction is performed while the dissolution adjuvant is distilled away. In the case where a monomer having low miscibility is present, a condensation reaction of the monomers with an acid or alcohol that is to undergo a polycondensation reaction with the monomers may be performed in advance and subsequently polycondensation of the resulting polymers with the other components may be performed.

The crystalline resin is described below.

Examples of the crystalline resin include the crystalline resins known in the related art, such as a crystalline polyester resin and a crystalline vinyl resin (e.g., a polyalkylene resin or a long-chain alkyl (meth)acrylate resin). Among these, a crystalline polyester resin may be used in consideration of the mechanical strength and low temperature fixability of the toner.

### Crystalline Polyester Resin

Examples of the crystalline polyester resin include condensation polymers of a polyvalent carboxylic acid and a polyhydric alcohol. The crystalline polyester resin may be commercially available one or a synthesized one.

In order to increase ease of forming a crystal structure, a condensation polymer prepared from linear aliphatic polymerizable monomers may be used as a crystalline polyester resin instead of a condensation polymer prepared from polymerizable monomers having an aromatic ring.

Examples of the polyvalent carboxylic acid include aliphatic dicarboxylic acids, such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; aromatic dicarboxylic acids, such as dibasic acids (e.g., phthalic acid, isophthalic acid, terephthalic acid, and naphthalene-2,6-dicarboxylic acid); anhydrides of these dicarboxylic acids; and lower (e.g., 1 to 5 carbon atoms) alkyl esters of these dicarboxylic acids.

Trivalent or higher carboxylic acids having a crosslinked structure or a branched structure may be used as a polyvalent carboxylic acid in combination with the dicarboxylic acids. Examples of the trivalent carboxylic acids include aromatic carboxylic acids, such as 1,2,3-benzenetricarboxylic acid, 1,2,4-benzenetricarboxylic acid, and 1,2,4-naphthalenetricarboxylic acid; anhydrides of these tricarboxylic acids; and lower (e.g., 1 to 5 carbon atoms) alkyl esters of these tricarboxylic acids.

Dicarboxylic acids including a sulfonic group and dicarboxylic acids including an ethylenic double bond may be used as a polyvalent carboxylic acid in combination with the above dicarboxylic acids.

The above polyvalent carboxylic acids may be used alone or in combination of two or more.

Examples of the polyhydric alcohol include aliphatic diols, such as linear aliphatic diols including a backbone having 7 to 20 carbon atoms. Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these aliphatic diols, 1,8-octanediol, 1,9-nonanediol, and 1,10-decanediol may be used.

Trihydric or higher alcohols having a crosslinked structure or a branched structure may be used as a polyhydric alcohol in combination with the above diols. Examples of the trihydric or higher alcohols include glycerin, trimethylolethane, trimethylolpropane, and pentaerythritol.

The above polyhydric alcohols may be used alone or in combination of two or more.

The content of the aliphatic diols in the polyhydric alcohol may be 80 mol % or more and is preferably 90 mol % or more.

The melting temperature of the crystalline polyester resin is preferably 50° C. or more and 100° C. or less, is more preferably 55° C. or more and 90° C. or less, and is further preferably 60° C. or more and 85° C. or less.

The melting temperature of the crystalline polyester resin is determined from the “melting peak temperature” according to a method for determining melting temperature which is described in JIS K 7121:1987 “Testing Methods for Transition Temperatures of Plastics” using a DSC curve obtained by differential scanning calorimetry (DSC).

The crystalline polyester resin may have a weight average molecular weight Mw of 6,000 or more and 50,000 or less.

The crystalline polyester resin may be produced by any suitable method known in the related art similarly to, for example, the amorphous polyester resin.

In the case where the toner includes the crystalline resin, the proportion of the crystalline resin to the entirety of the binder resin is preferably 15% by mass or more and 40% by mass or less and is more preferably 17% by mass or more and 37% by mass or less.

When the proportion of the crystalline resin falls within the above range, the deformation of the toner particles during the fixation falls within an adequate range and, as a result, low temperature fixability may be achieved.

The binder resin may include the amorphous polyester resin and the crystalline polyester resin in order to maintain the affinity between the binder resin and the resin particles. In the case where the binder resin includes the amorphous polyester resin and the crystalline polyester resin, since both of them include an aliphatic dicarboxylic acid unit, it becomes possible to disperse the resin particles in a further homogeneous manner.

As an aliphatic dicarboxylic acid, for example, a saturated aliphatic dicarboxylic acid represented by HOOC—(CH₂)ₙ—COOH may be used, where n is preferably 4 to 20 and is further preferably 4 to 12.

The content of the binder resin is, for example, preferably 40% by mass or more and 98% by mass or less, is more preferably 50% by mass or more and 95% by mass or less, and is further preferably 60% by mass or more and 93% by mass or less of the whole amount of the toner.

### Resin Particles

As described above, the electrostatic image developing toner according to this exemplary embodiment includes a binder resin and resin particles immiscible with the binder resin (hereinafter, referred to as “specific resin particles”).

The specific resin particles may be crosslinked particles. When crosslinked particles are used, the elasticity of the toner may be enhanced and, consequently, the adhesion of images to one another may be reduced.

Examples of the crosslinked particles include particles crosslinked with an ionic bond (ion-crosslinked particles) and particles crosslinked with a covalent bond (covalent bond-crosslinked particles). Among these crosslinked particles, covalent bond-crosslinked particles may be used.

Examples of types of the resin constituting the specific resin particles include a polyolefin resin (e.g., polyethylene or polypropylene), a styrene resin (e.g., polystyrene, α-polymethylstyrene), a (meth)acrylic resin (e.g., polymethyl methacrylate or polyacrylonitrile), an epoxy resin, a polyurethane resin, a polyurea resin, a polyamide resin, a polyamide resin, a polycarbonate resin, a polyether resin, a polyester resin, and resins produced by copolymerization of the above resins. The above resins may be used alone or in a mixture of two or more as needed.

Among the above resins, a styrene-(meth)acrylate copolymer may be included in the resin constituting the specific resin particles. Specifically, it is preferable that the content of the styrene-(meth)acrylate copolymer that serves as a principal component in the resin particles be 50% by mass or more. The content of the styrene-(meth)acrylate copolymer is preferably 80% by mass or more and is more preferably 90% by mass or more. In particular, it is preferable that the specific resin particles substantially be composed only of a styrene-(meth)acrylate copolymer. The ratio of the total amount of the styrene monomer and (meth)acrylic monomer to the amount of monomers constituting the copolymer is preferably 80% by mass or more, is further preferably 90% by mass or more, and is particularly preferably 95% by mass or more. Note that the balance is the crosslinking agent described below. It is particularly preferable that the resin particles be converted into the crosslinked particles by the addition of the crosslinking agent.

When the specific resin particles are particles of a styrene-(meth)acrylate copolymer, a toner that enables a reduction in the adhesion of images to one another and improvement of low temperature fixability may be readily produced.

The styrene-(meth)acrylate copolymer is, for example, a resin produced by polymerizing the styrene monomer and (meth)acrylate monomer described below by radical polymerization.

Examples of the styrene monomer include styrene, α-methylstyrene, vinylnaphthalene, alkyl-substituted styrenes having an alkyl chain, such as 2-methylstyrene, 3-methylstyrene, 4-methylstyrene, 2-ethylstyrene, 3-ethylstyrene, and 4-ethylstyrene, halogen-substituted styrenes, such as 2-chlorostyrene, 3-chlorostyrene, and 4-chlorostyrene, and fluorine-substituted styrenes, such as 4-fluorostyrene and 2,5-difluorostyrene. Among these, styrene and α-methylstyrene are preferable.

Examples of the (meth)acrylate monomer include (meth)acrylic acid, n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, 2-carboxyethyl (meth)acrylate, (meth)acrylonitrile, and (meth)acrylamide. Among these, n-butyl (meth)acrylate and 2-carboxyethyl (meth)acrylate are preferable.

Examples of the crosslinking agent used for crosslinking the resins to form the crosslinked particles include aromatic polyvinyl compounds, such as divinylbenzene and divinylnaphthalene; polyvinyl esters of aromatic polyvalent carboxylic acids, such as divinyl phthalate, divinyl isophthalate, divinyl terephthalate, divinyl homophthalate, trimesic acid divinyl ester, trimesic acid trivinyl ester, divinyl naphthalenedicarboxylate, and divinyl biphenylcarboxylate; divinyl esters of nitrogen-containing aromatic compounds, such as divinyl pyridinedicarboxylate; vinyl esters of unsaturated heterocyclic carboxylic acid compounds, such as vinyl pyromucate, vinyl furancarboxylate, vinyl pyrrole-2-carboxylate, and vinyl thiophenecarboxylate; (meth)acrylic acid esters of linear polyhydric alcohols, such as butanediol diacrylate, butanediol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, dodecanediol diacrylate, and dodecanediol dimethacrylate; (meth)acrylic acid esters of branched or substituted polyhydric alcohols, such as neopentyl glycol dimethacrylate and 2-hydroxy,1,3-diacryloxypropane; and polyvinyl esters of polyvalent carboxylic acids, such as polyethylene glycol di(meth)acrylate, polypropylene polyethylene glycol di(meth)acrylates, divinyl succinate, divinyl fumarate, vinyl maleate, divinyl maleate, divinyl diglycolate, vinyl itaconate, divinyl itaconate, divinyl acetonedicarboxylate, divinyl glutarate, divinyl 3,3′-thiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. The above crosslinking agents may be used alone or in combination of two or more.

Among these, a difunctional alkyl acrylate including an alkylene chain having 6 or more carbon atoms may be used as a crosslinking agent for crosslinking the specific resin. That is, the crosslinked resin particles may include a difunctional alkyl acrylate as a structural unit and the number of carbon atoms included in the alkylene chain of the difunctional alkyl acrylate may be 6 or more.

When crosslinked particles that include a difunctional alkyl acrylate as a structural unit, the number of carbon atoms included in the alkylene chain of the difunctional alkyl acrylate being 6 or more, is used, the deformation of the toner particles during the fixation falls within an adequate range and, as a result, a toner having suitable low temperature fixability may be readily produced. If the crosslinking density of the resin particles is high (i.e., the distance between crosslinks is short), elasticity is increased to an excessive degree. In contrast, in the case where a difunctional acrylate having a long alkylene chain is used as a crosslinking agent, the crosslinking density is low (i.e., the distance between crosslinks is long) and the excessive increase in the elasticity of the specific resin particles may be avoided.

In order to adjust the crosslinking density to fall within an adequate range, the number of carbon atoms included in the alkylene chain of the difunctional alkyl acrylate is preferably 6 or more, is more preferably 6 or more and 12 or less, and is further preferably 8 or more and 12 or less. Specific examples of the difunctional alkyl acrylate include 1,6-hexanediol acrylate, 1,6-hexanediol methacrylate, 1,8-octanediol diacrylate, 1,8-octanediol dimethacrylate, 1,9-nonanediol diacrylate, 1,9-nonanediol dimethacrylate, 1,10-decanediol diacrylate, 1,10-decanediol dimethacrylate, 1,12-dodecanediol diacrylate, and 1,12-dodecanediol dimethacrylate. Among these, 1,10-decanediol diacrylate and 1,10-decanediol dimethacrylate may be used.

Other examples of the crosslinking agent include 2-carboxyethyl acrylate. At least one of the difunctional alkyl acrylate described above and 2-carboxyethyl acrylate may be used.

In the case where the specific resin particles are composed of a polymer formed using a resin particle-forming composition that includes a styrene monomer, a (meth)acrylate monomer, and a crosslinking agent, the fixability of the resin particles may be controlled by adjusting the content of the crosslinking agent in the composition. For example, increasing the content of the crosslinking agent in the composition increases the likelihood of formation of resin particles having suitable fixability. The content of the crosslinking agent in the specific resin particle-forming composition is, for example, preferably 0.3 parts by mass or more and 5.0 parts by mass or less, is more preferably 0.5 parts by mass or more and 3.0 parts by mass or less, and is further preferably 0.8 parts by mass or more and 2.5 parts by mass or less relative to 100 parts by mass of total amount of the styrene monomer, the (meth)acrylate monomer, and the crosslinking agent.

The glass transition temperature Tg(E) of the specific resin particles which is measured with a differential scanning calorimeter is preferably 0° C. or more and 30° C. or less and is more preferably 5° C. or more and 25° C. or less.

When the glass transition temperature Tg(E) of the specific resin particles is 0° C. or more and 30° C. or less, the toner may have suitable low temperature fixability. If the glass transition temperature of the specific resin particles is more than 30° C., the adhesion of the toner, which includes the resin particles having a high glass transition temperature, to paper sheets is reduced. As a result, it is likely to become difficult to achieve suitable low temperature fixability simultaneously. If particles having a glass transition temperature of 0° C. or less, such as rubber particles, are used, the toner constantly behaves elastically at normal to high temperatures and it is likely to become difficult to achieve suitable low temperature fixability simultaneously.

As described above, when the glass transition temperature of the resin particles which is determined using a Fox equation on the basis of the proportions of monomers constituting the entire resin particles is defined as Tg(C1)° C., the difference between Tg(C1) and the measured glass transition temperature Tg(E)° C. of the resin particles satisfies:

$$5.0 \leq T g ( E ) - T g ( C 1 ) \leq 20.0$$

When the glass transition temperature of the resin particles which is determined using a Fox equation on the basis of the monomer proportions calculated by surface analysis of the resin particles is defined as Tg(C2)° C.,

$$Tg ( C 1 ) < Tg ( C 2 )$$

When the above two conditions are satisfied, a toner that enables a reduction in the adhesion of images to one another and has low temperature fixability may be produced. Further preferably, the following condition is satisfied:

$$8.0 \leq T g ( E ) - T g ( C 1 ) \leq 18.0$$

The relationship “5.0≤Tg(E)−Tg(C1)≤20.0” means that the measured glass transition temperature Tg(E) of the resin particles is higher than the glass transition temperature Tg(C1) calculated using a Fox equation, and the difference therebetween falls within a specific range. As described above, the difference between the glass transition temperature based on a Fox equation and the measured glass transition temperature means that styrene and (meth)acrylate are not bonded to each other in a random manner and that a sequence in which a component derived from styrene is primarily localized and a sequence in which a component derived from (meth)acrylate is primarily localized are present in a mixed manner.

The relationship “Tg(C1)<Tg(C2)” means that, among glass transition temperatures calculated using a Fox equation, the glass transition temperature Tg(C1) calculated with respect to the entire resin particles is lower than the glass transition temperature Tg(C2) calculated on the basis of the monomer proportions calculated by surface analysis. The glass transition temperature of a polystyrene resin is about 100° C. The glass transition temperature of a (meth) acrylic resin is normally lower than that of a polystyrene resin. For example, the glass transition temperature of polyethyl acrylate is about −20° C. Therefore, it is considered that a region in which a styrene unit is primarily present is localized in the surfaces of the specific resin particles.

An electrostatic image developing toner according to a second embodiment of the present disclosure is, for example, an electrostatic image developing toner including a binder resin and specific resin particles. The binder resin includes an amorphous resin and a crystalline resin. The specific resin particles include a styrene-(meth)acrylate copolymer. When the proportion of a unit derived from a styrene monomer included in the specific resin particles is defined as Ws(B) mol % and the proportion of a unit derived from a styrene monomer, the proportion being determined by surface analysis of the specific resin particles, is defined as Ws(S) mol %,

Ws(S) is 40 mol % or more and 80 mol % or less, and

$$2 \leq W s ( S ) - W s ( B ) \leq 20 .$$

In the second embodiment, Ws(S) is preferably 45 mol % or more and 75 mol % or less, and

5≤Ws(S)−Ws(B)≤15 is preferable.

In either of the exemplary embodiments, it is necessary that the resin particles include a region in which a styrene unit is the principal component and a region in which a (meth)acrylate unit is the principal component and a styrene unit be localized in the surfaces of the specific resin particles.

In contrast, for example, in the case where the resin particles have a clear core-shell structure as a result of seeded polymerization or the like, the resin particles do not become deformed unless a certain pressure is not applied to the resin particles. Consequently, low temperature fixability may become degraded when the type of sheet or fixation is changed.

The preferable range of Ws(B) varies by the type of the (meth)acrylate monomer selected. Ws(B) may be, for example, 30 mol % or more and 70 mol % or less.

Tg(E), Tg(C2), Ws(S), etc. of the specific resin particles composed of the styrene-(meth)acrylate copolymer can be adjusted by changing the polymerization conditions under which the copolymer is produced.

In particular, in order to produce resin particles having a compositional gradient inside resin particles and a region in which a styrene unit is primarily present, the region being localized in the surfaces of the resin particles, as in the above two exemplary embodiments, in the production of the resin particles by polymerization of a monomer-containing liquid including styrene and (meth)acrylate, the ratio of the styrene content in the monomer-containing liquid to the content of (meth)acrylate in the monomer-containing liquid may be increased with the progress of the polymerization. The expression “increased with the progress of the polymerization” typically means that the proportion of the styrene content in the monomer-containing liquid is gradually increased and also means that, for example, when an additional monomer is added to the monomer-containing liquid in a plurality of stages, the styrene content in the additional monomer is gradually increased or the amount of the styrene monomer added is increased to gradually increase the styrene concentration in the monomer-containing liquid. For example, in the case where a styrene-(meth)acrylate copolymer is prepared by emulsion polymerization, when an emulsion is added dropwise in a plurality of stages, the styrene content in the emulsion may be gradually increased.

The progress of the reaction may be controlled by changing the polymerization temperature, the amount of polymerization time, the method of addition of polymerization initiator, and the like in a combined manner.

The proportion Ws(S) of the unit derived from the styrene monomer which is determined by surface analysis is determined in the following manner.

The resin particles are dried and the composition of the surfaces of the resin particles is analyzed with X-ray photoelectron spectroscopy (XPS). The ratio O(p) of the amount of oxygen atoms to the total amount of the carbon and oxygen atoms included in the resin particles is calculated using the formula below.

$$O ( p ) = Number of oxygen atoms / ( Number of carbon atoms + Number of oxygen atoms )$$

A resin composed only of (meth)acrylate is prepared, and the proportion O(a) of oxygen atoms in the (meth)acrylate is determined in the same manner as described above.

On the basis of the above measurement results, with the sum of styrene and (meth)acrylate being defined as 1, the proportion Wa(S) of (meth)acrylate present on the surfaces and the proportion Ws(S) of styrene present on the surfaces may be calculated using the formulae below.

$$Wa ( S ) = O ( p ) / O ( a )$$

$$Ws ( S ) = 1 - ( O ( p ) / O ( a ) )$$

Tg(C2) can be calculated using the above ratios.

The content of the specific resin particles is preferably 2% by mass or more and 20% by mass or less and is more preferably 5% by mass or more and 15% by mass or less of the total amount of the toner.

When the content of the specific resin particles falls within the above range, the reduction in the adhesion of images to one another and low temperature fixability may be both achieved.

The ratio w1/w2 of the content w1 of the specific resin particles in the toner to the content w2 of the crystalline resin in the toner is preferably 0.2 or more and 2.0 or less and is further preferably 0.3 or more and 1.5 or less.

When the ratio w1/w2 falls within the above range, the proportions of the crystalline resin and the specific resin particles fall within a specific range, the toner particles may be capable of becoming deformed to an adequate degree during fixation, and a toner having suitable low temperature fixability may be produced.

In the case where the amorphous resin includes an amorphous polyester resin, when the glass transition temperature of the amorphous polyester resin which is measured with a differential scanning calorimeter is defined as Tg(ap)° C., the difference between Tg(ap) and the glass transition temperature Tg(C1)° C. calculated using a Fox equation on the basis of the proportions of monomers constituting the entire resin particles may satisfy:

$$40 \leq T g ( a p ) - T g ( C 1 ) \leq 90$$

When the above condition is satisfied, the affinity between the binder resin and the resin particles may be controlled.

Note that the measured glass transition temperature Tg(ap) of the amorphous polyester resin may be a Tg obtained by dissolving the toner in THF to remove insoluble components, storing the extract at, for example, 40° C. to 55° C. to cause crystallization to a sufficient degree, and subsequently measuring Tg with a differential scanning calorimeter. In the case where the resin particles are crosslinked particles, the proportions of the monomers constituting the entire specific resin particles are obtained by measuring the proportions of monomers constituting resin particles taken from the toner as THF insoluble components.

When the SP value of the entire binder resin which is calculated using a Fedors method is defined as SP(1) and the SP value of the specific resin particles which is calculated using a Fedors method on the basis of the monomer composition determined by surface analysis is defined as SP(2), the condition below is preferably satisfied:

$$\vert SP ( 1 ) - SP ( 2 ) \vert \geq 0.15$$

The condition below is further preferably satisfied:

$$\vert SP ( 1 ) - SP ( 2 ) \vert \geq 0.18$$

As described above, when the difference between the two types of SP values is 0.15 or more, the affinity between the binder resin and the specific resin particles may be controlled.

Note that the monomer composition of the specific resin particles obtained by surface analysis is determined by conducting surface analysis by X-ray photoelectron spectroscopy (XPS). In the present disclosure, “JPS-9000MX” produced by JEOL Ltd. is used as an XPS measuring system. In the measurement, MgKα radiation is used as an X-ray source, the acceleration voltage is set to 10 kV, and the emission current is set to 30 mA.

Specifically, the specific resin particles are taken from the toner as a THF insoluble component as in the calculation of Tg(C1) above and the monomer composition of the surfaces is measured.

In the calculation of the SP value of the entire binder resin which is calculated using a Fedors method, that is, SP(2), the toner is dissolved in THF to remove the insoluble components and the monomer composition is determined on the basis of the NMR measurement of the extract.

Solubility parameter SP values, SP(ap) and SP(sa), (units: (cal/cm³)^{1/2}) are calculated using a Fedors method. Specifically, the SP values are calculated using the following formula.

$$SP value = √ ( Ev / v ) = √ ( \sum Δ ei / \sum Δ vi )$$

where Ev: evaporation energy (cal/mol), v: molar volume (cm³/mol), Δei: the evaporation energy of each atom or atomic group, and Δvi: the molar volume of each atom or atomic group

Details of the calculation method are described in, for example, Polym. Eng. Sci. vol. 14, p. 147 (1974), “Gijyutsu-sha no tameno Jitsugaku Koubunshi (Practical Polymers for Engineers)”, Mukai J, et al., p. 66, Kodansha, 1981, “Polymer Handbook”, fourth edition, Willey-interscience Publication. In this exemplary embodiment, the same method as described above is used.

In this exemplary embodiment, although the units of SP values is (cal/cm³)^{1/2}, the units are omitted and SP values are expressed as a dimensionless number in accordance with the practice.

The average equivalent circle diameter of domains formed by the specific resin particles in the toner is preferably 50 nm or more and 300 nm or less and is further preferably 80 nm or more and 250 nm or less. When the above average equivalent circle diameter falls within the above range, fixation is not inhibited and staining of a post-treatment device may be reduced.

The average equivalent circle diameter is measured by the following method.

The toner is mixed with an epoxy resin so as to be buried therein. The epoxy resin is then solidified. The resulting solid is sliced with an ultramicrotome device (“Ultracut UCT” produced by Leica) into a thin sample having a thickness of 80 nm or more and 130 nm or less. The thin sample is stained with ruthenium tetroxide for 3 hours in a desiccator at 30° C. A SEM image of the stained thin sample is obtained with a ultra-high resolution field emission scanning electron microscope (FE-SEM) “S-4800” produced by Hitachi High-Technologies Corporation. Since the ease of staining with ruthenium tetroxide varies in order of the release agent, the styrene-(meth)acrylic resin, and the polyester resin, the components are distinguished from one another in accordance with the color density resulting from the degree of staining. In the case where it is difficult to distinguish the color density due to the conditions of the sample, the amount of time during which staining is performed is adjusted.

Since domains of the colorant are smaller than domains of the release agent or domains of the resin particles in a cross section of the toner particles, they are distinguished from the other domains by size.

The average equivalent circle diameter of domains of the specific resin particles is measured by the following method.

In the SEM image, 30 cross sections of the toner particles whose maximum length is 85% or more of the volume average size of the toner particles are selected, and 100 domains of stained resin particles are observed in total. The maximum length of each of the domains is measured. The maximum length is considered as the diameter of the domain and the arithmetic average thereof is considered as an average equivalent circle diameter.

The average equivalent circle diameter of the domains of the specific resin particles is controlled by, for example, producing the toner particles by aggregation coalescence and adjusting the volume average size of the specific resin particles included in the specific resin particle dispersion liquid used in the production; or by preparing a plurality of specific resin particle dispersion liquids having different volume average particle sizes and using the dispersion liquids in combination with one another.

The average shape factor SF-1 of domains of the specific resin particles may be 130 or less. When SF-1 is 130 or less, fixation is not inhibited and staining of a post-treatment device may be reduced.

The average shape factor SF-1 is calculated using the formula below:

$$SF - 1 = ( ML / A ) \times ( π / 4 ) \times 100$$

where ML represents the absolute maximum length of a toner particle, and A represents the projected area of the toner particle.

Specifically, a sample is prepared as in the measurement of average equivalent circle diameter of domains. In the SEM image, 30 cross sections of the toner particles whose maximum length is 85% or more of the volume average size of the toner particles are selected, and 100 domains of stained resin particles are observed in total. The observed SEM image is captured into an image analysis processing system LUZEX (produced by NIRECO CORPORATION) to measure the maximum lengths and projected areas of the 100 particles. Then, calculation is done using the above formula, and the average thereof is calculated.

### Colorant

Examples of the colorant include pigments, such as Carbon Black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watching Red, Permanent Red, Brilliant Carmine 3B, Brilliant Carmine 6B, DuPont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate; and dyes, such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

The above colorants may be used alone or in combination of two or more.

The colorant may optionally be subjected to a surface treatment and may be used in combination with a dispersant. Plural types of colorants may be used in combination.

For example, the content of the colorant in the entire toner particles is preferably 1% by mass or more and 30% by mass or less and is more preferably 3% by mass or more and 15% by mass or less.

### Release Agent

Examples of the release agent include, but are not limited to, hydrocarbon waxes; natural waxes, such as a carnauba wax, a rice bran wax, and a candelilla wax; synthetic or mineral-petroleum-derived waxes, such as a montan wax; and ester waxes, such as a fatty-acid ester wax and a montanate wax.

The melting temperature of the release agent is preferably 50° C. or more and 110° C. or less and is more preferably 60° C. or more and 100° C. or less.

The above melting temperature is determined from the “melting peak temperature” according to a method for determining melting temperature which is described in JIS K 7121:1987 “Testing Methods for Transition Temperatures of Plastics” using a DSC curve obtained by differential scanning calorimetry (DSC).

For example, the content of the release agent in the entire toner particles is preferably 1% by mass or more and 20% by mass or less and is more preferably 4% by mass or more and 15% by mass or less.

### Other Additives

Examples of the other additives include additives known in the related art, such as a magnetic substance, a charge-controlling agent, and an inorganic powder. These additives may be added to the toner particles as internal additives.

### Properties, Etc. of Toner Particles

The toner particles may have a single-layer structure or a “core-shell” structure constituted by a core (i.e., core particle) and a coating layer (i.e., shell layer) covering the core.

The core-shell structure of the toner particles may be constituted by, for example, a core including the binder resin, the specific resin particles, and, as needed, other additives such as a colorant and a release agent and by a coating layer including the binder resin and the resin particles.

The volume average diameter D50v of the toner particles is preferably 2 μm or more and 10 μm or less, is more preferably 4 μm or more and 8 μm or less, and is further preferably 4 μm or more and 7 μm or less.

The various average particle sizes and various particle size distribution indices of the toner particles are measured using “COULTER MULTISIZER 3” produced by Beckman Coulter, Inc. with an electrolyte “ISOTON-II” produced by Beckman Coulter, Inc. in the following manner.

A sample to be measured (0.5 mg or more and 50 mg or less) is added to 2 ml of a 5%-aqueous solution of a surfactant (e.g., sodium alkylbenzene sulfonate) that serves as a dispersant. The resulting mixture is added to 100 ml or more and 150 ml or less of an electrolyte.

The resulting electrolyte containing the sample suspended therein is subjected to a dispersion treatment for 1 minute using an ultrasonic disperser, and the distribution of the diameters of particles having a diameter of 2 μm or more and 60 μm or less is measured using COULTER MULTISIZER II with an aperture having a diameter of 100 m. The number of the particles sampled is 50,000.

The toner particles preferably has an average circularity of 0.94 or more and 1.00 or less. The average circularity of the toner particles is more preferably 0.95 or more and 0.98 or less.

The average circularity of the toner particles is determined as [Equivalent circle perimeter]/[Perimeter] (i.e., [Perimeter of a circle having the same projection area as the particles]/[Perimeter of the projection image of the particles]. Specifically, the average circularity of the toner particles is determined by the following method.

The toner particles to be measured are sampled by suction so as to form a flat stream. A static image of the particles is taken by instantaneously flashing a strobe light. The image of the particles is analyzed with a flow particle image analyzer “FPIA-3000” produced by Sysmex Corporation. The number of samples used for determining the average circularity of the toner particles is 4,500.

In the case where the toner includes an external additive, the toner (i.e., the developer) to be measured is dispersed in water containing a surfactant and then subjected to an ultrasonic wave treatment in order to remove the external additive from the toner particles.

### External Additive

Examples of the external additive include inorganic particles. Examples of the inorganic particles include SiO₂ particles, TiO₂ particles, Al₂O₃ particles, CuO particles, ZnO particles, SnO₂ particles, CeO₂ particles, Fe₂O₃ particles, MgO particles, BaO particles, CaO particles, K₂O particles, Na₂O particles, ZrO₂ particles, CaO·SiO₂ particles, K₂O·(TiO₂)ₙ particles, Al₂O₃·2SiO₂ particles, CaCO₃ particles, MgCO₃ particles, BaSO₄ particles, and MgSO₄ particles.

The surfaces of the inorganic particles used as an external additive may be subjected to a hydrophobic treatment. The hydrophobic treatment is performed by, for example, immersing the inorganic particles in a hydrophobizing agent. Examples of the hydrophobizing agent include, but are not limited to, a silane coupling agent, a silicone oil, a titanate coupling agent, and aluminum coupling agent. These hydrophobizing agents may be used alone or in combination of two or more.

The amount of the hydrophobizing agent is commonly, for example, 1 part by mass or more and 10 parts by mass or less relative to 100 parts by mass of the inorganic particles.

Examples of the external additive further include particles of a resin, such as polystyrene, polymethyl methacrylate (PMMA), or a melamine resin; and particles of a cleaning lubricant, such as a metal salt of a higher fatty acid, such as zinc stearate, or a fluorine-contained resin.

The amount of the external additive used is, for example, preferably 0.01% by mass or more and 8.0% by mass or less and is more preferably 0.2% by mass or more and 6.0% by mass or less of the amount of the toner particles.

### Method for Producing Toner

A method for producing the toner according to this exemplary embodiment is described below.

The toner according to the exemplary embodiment is produced by, after the preparation of the toner particles, depositing an external additive on the surfaces of the toner particles as needed.

The toner particles may be prepared by any dry process, such as knead pulverization, or any wet process, such as aggregation coalescence, suspension polymerization, or dissolution suspension. However, a method for preparing the toner particles is not limited thereto, and any suitable method known in the related art may be used.

Among these methods, aggregation coalescence may be used in order to prepare the toner particles.

Specifically, for example, in the case where aggregation coalescence is used for producing the toner particles, the toner particles are produced by the following steps:
preparing a binder resin particle dispersion liquid in which particles of a resin that serves as a binder resin are dispersed and a specific resin particle dispersion liquid that serves as the specific resin particles (specific resin particle dispersion liquid preparation step);
causing the specific resin particles (and other particles as needed) to aggregate with one another in the binder resin particle dispersion liquid (or a dispersion liquid that further includes the other particle dispersion liquid as needed) to form aggregated particles (aggregated particle formation step); and
heating the resulting aggregated particle dispersion liquid in which the aggregated particles are dispersed to cause fusion and coalescence of the aggregated particles and form toner particles (fusion and coalescence step).

Each of the above steps is described below in detail.

Hereinafter, a method for preparing toner particles including a colorant and a release agent is described. However, it should be noted that the colorant and the release agent are optional. It is needless to say that additives other than a colorant or a release agent may be used.

### Binder Resin Particle Dispersion Liquid Preparation Step

First, a binder resin particle dispersion liquid in which particles of a resin that serves as a binder resin are dispersed is prepared. Furthermore, for example, a colorant particle dispersion liquid in which particles of a colorant are dispersed and a release agent particle dispersion liquid in which particles of a release agent are dispersed are prepared.

The binder resin particle dispersion liquid is prepared by, for example, emulsifying the binder resin and dispersing the binder resin particles in a dispersion medium using a surfactant as needed.

Examples of the dispersion medium used for preparing the binder resin particle dispersion liquid include aqueous media.

Examples of the aqueous media include water, such as distilled water and ion-exchange water; and alcohols. These aqueous media may be used alone or in combination of two or more.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. Among these surfactants, in particular, the anionic surfactants and the cationic surfactants may be used. The nonionic surfactants may be used in combination with the anionic surfactants and the cationic surfactants.

These surfactants may be used alone or in combination of two or more.

In the preparation of the binder resin particle dispersion liquid, the binder resin particles can be dispersed in a dispersion medium by any suitable dispersion method commonly used in the related art in which, for example, a rotary-shearing homogenizer, a ball mill, a sand mill, or a dyno mill that includes media is used. Depending on the type of the binder resin particles used, the binder resin particles may be dispersed in the binder resin particle dispersion liquid by, for example, phase-inversion emulsification.

Phase-inversion emulsification is a method in which the resin to be dispersed is dissolved in a hydrophobic organic solvent in which the resin is soluble, a base is added to the resulting organic continuous phase (i.e., O phase) to perform neutralization, and subsequently an aqueous medium (i.e., W phase) is charged in order to perform conversion of resin (i.e., phase inversion) from W/O to O/W, form a discontinuous phase, and disperse the resin in the aqueous medium in the form of particles.

The volume average diameter of the resin particles dispersed in the binder resin particle dispersion liquid is preferably, for example, 0.01 μm or more and 1 μm or less, is more preferably 0.08 μm or more and 0.8 μm or less, and is further preferably 0.1 μm or more and 0.6 μm or less.

The volume average diameter of the binder resin particles is determined in the following manner. The particle diameter distribution of the resin particles is obtained using a laser-diffraction particle-size-distribution measurement apparatus, such as “LA-700” produced by HORIBA, Ltd. The particle diameter distribution measured is divided into a number of particle diameter ranges (i.e., channels). For each range, in ascending order in terms of particle diameter, the cumulative volume is calculated and plotted to draw a cumulative distribution curve. A particle diameter at which the cumulative volume reaches 50% is considered to be the volume particle diameter D50v. The volume average diameters of particles included in the other dispersion liquids are also determined in the above-described manner.

The content of the resin particles included in the binder resin particle dispersion liquid is, for example, preferably 5% by mass or more and 50% by mass or less and is more preferably 10% by mass or more and 40% by mass or less.

The colorant particle dispersion liquid, the release agent particle dispersion liquid, and the like are also prepared as in the preparation of the binder resin particle dispersion liquid. In other words, the above-described specifications for the volume average diameter of the particles included in the binder resin particle dispersion liquid, the dispersion medium of the binder resin particle dispersion liquid, the dispersion method used for preparing the binder resin particle dispersion liquid, and the content of the particles in the binder resin particle dispersion liquid can also be applied to colorant particles dispersed in the colorant particle dispersion liquid and release agent particles dispersed in the release agent particle dispersion liquid.

### Preparation of Specific Resin Particle Dispersion Liquid

Publicly known methods, such as emulsion polymerization, a melt-kneading method in which a Banbury mixer, a kneader, or the like is used, suspension polymerization, and spray drying, may be used for preparing the specific resin particle dispersion liquid. Among these, emulsion polymerization may be used for localizing a unit derived from styrene at the surfaces of the particles.

A styrene monomer and a (meth)acrylate monomer may be used as monomers and polymerized with each other in the presence of a crosslinking agent. In the production of the specific resin particles, emulsion polymerization may be performed in a plurality of stages.

The method for producing the specific resin particles is specifically described below.

The method for preparing the specific resin particle dispersion liquid may include the following steps:
preparing an emulsion including monomers, a crosslinking agent, a surfactant, and water (emulsion preparation step);
adding a polymerization initiator to the emulsion and heating the resulting mixture to cause polymerization of the monomers (first emulsion polymerization step); and
adding an emulsion including monomers and a crosslinking agent to the reaction solution produced by the first emulsion polymerization step and heating the resulting mixture to cause polymerization of the monomers (second emulsion polymerization step).

In the second emulsion polymerization step, furthermore, emulsions including the styrene monomer and the (meth)acrylate monomer at different proportions may be prepared and added to the reaction solution in plurality of stages in order to adjust the composition of the surfaces of the particles.

### Emulsion Preparation Step

The emulsion preparation step is a step of preparing an emulsion including monomers, a crosslinking agent, a surfactant, and water.

The emulsion may be prepared by emulsifying monomers, a crosslinking agent, a surfactant, and water with an emulsifier.

Examples of the emulsifier include a rotary stirrer equipped with a propeller-type, anchor-type, paddle-type, or turbine-type impeller; a static mixing machine, such as a static mixer; a homogenizer; a rotor-stator emulsifier, such as CLEARMIX; a mill emulsifier having a grinding function; a high-pressure emulsifier, such as a Manton-Gaulin pressure emulsifier; a high-pressure nozzle emulsifier that generates cavitation at high pressures; a high-pressure collision emulsifier that generates a shear force by causing liquid particles to collide with one another at high pressures, such as Microfluidizer; an ultrasonic emulsifier that generates cavitation using ultrasonic waves; and a membrane emulsifier that performs homogeneous emulsification through pores.

A styrene monomer and a (meth)acrylate monomer may be used as monomers.

The crosslinking agent may be the above-described crosslinking agent.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. The nonionic surfactants may be used in combination with the anionic surfactants and the cationic surfactants. Among these surfactants, the anionic surfactants may be used. These surfactants may be used alone or in combination of two or more.

The emulsion may include a chain transfer agent. The chain transfer agent may be, but not limited to, a compound having a thiol component. Specific examples thereof include alkyl mercaptans, such as hexyl mercaptan, heptyl mercaptan, octyl mercaptan, nonyl mercaptan, decyl mercaptan, and dodecyl mercaptan.

The mass ratio between the styrene monomer and (meth)acrylate monomer included in the emulsion (styrene monomer/(meth)acrylate monomer) may be 0.2 or more and 1.1 or less.

The content of the crosslinking agent may be 0.5% by mass or more and 3% by mass or less of the total amount of the emulsion.

### First Emulsion Polymerization Step

The first emulsion polymerization step is a step of adding a polymerization initiator to the emulsion and heating the resulting mixture to cause polymerization of the monomers.

When polymerization is performed, the emulsion (reaction solution) including the polymerization initiator may be stirred with a stirrer.

Examples of the stirrer include a rotary stirrer equipped with a propeller-type, anchor-type, paddle-type, or turbine-type impeller.

Ammonium persulfate may be used as a polymerization initiator.

### Second Emulsion Polymerization Step

The second emulsion polymerization step is a step of adding an emulsion including monomers to the reaction solution produced in the first emulsion polymerization step and heating the resulting mixture to cause polymerization of the monomers.

When polymerization is performed, the reaction solution may be stirred as in the first emulsion polymerization step.

In this step, the emulsion may be added to the reaction solution in a plurality of stages in small amounts while the ratio between the styrene monomer and the (meth)acrylate monomer included in the emulsion is changed.

The emulsion including monomers may be produced by, for example, emulsifying the monomer, a surfactant, and water with an emulsifier.

### Aggregated Particle Formation Step

The binder resin particle dispersion liquid is mixed with the colorant particle dispersion liquid, the release agent particle dispersion liquid, and the specific resin particle dispersion liquid.

In the resulting mixed dispersion liquid, heteroaggregation of the resin particles with the colorant particles and the release agent particles is performed in order to form aggregated particles including the resin particles, the colorant particles, and the release agent particles, the aggregated particles having a diameter closer to that of the intended toner particles.

Specifically, for example, a coagulant is added to the mixed dispersion liquid, and the pH of the mixed dispersion liquid is controlled to be acidic (e.g., pH of 2 or more and 5 or less). A dispersion stabilizer may be added to the mixed dispersion liquid as needed. Subsequently, the mixed dispersion liquid is heated to the glass transition temperature of the binder resin particles (specifically, e.g., [Glass transition temperature of the binder resin particles—30° C.] or more and [the Glass transition temperature—10° C.] or less), and thereby the particles dispersed in the mixed dispersion liquid are caused to aggregate together to form aggregated particles.

In the aggregated particle formation step, alternatively, for example, the above coagulant may be added to the mixed dispersion liquid at room temperature (e.g., 25° C.) while the mixed dispersion liquid is stirred using a rotary-shearing homogenizer. Then, the pH of the mixed dispersion liquid is controlled to be acidic (e.g., pH of 2 or more and 5 or less), and a dispersion stabilizer may be added to the mixed dispersion liquid as needed. Subsequently, the mixed dispersion liquid is heated in the above-described manner.

In this step, the state in which the resin particles are dispersed in the toner particles may be controlled by adjusting the temperature of the mixed dispersion liquid to which the coagulant is added. For example, reducing the temperature of the mixed dispersion liquid enhances the dispersibility of the resin particles. The temperature of the mixed dispersion liquid is, for example, 5° C. or more and 40° C. or less.

In this step, the state in which the resin particles are dispersed in the toner particles may be also controlled by adjusting the agitation speed subsequent to the addition of the coagulant. For example, increasing the agitation speed subsequent to the addition of the coagulant enhances the dispersibility of the resin particles.

Examples of the coagulant include surfactants, inorganic metal salts, and divalent or higher metal complexes that have a polarity opposite to that of the surfactant included in the mixed dispersion liquid as a dispersant. In particular, using a metal complex as a coagulant reduces the amount of surfactant used and, as a result, charging characteristics may be enhanced.

An additive capable of forming a complex or a bond similar to a complex with the metal ions contained in the coagulant may optionally be used. An example of the additive is a chelating agent.

Examples of the inorganic metal salts include metal salts, such as calcium chloride, calcium nitrate, barium chloride, magnesium chloride, zinc chloride, aluminum chloride, and aluminum sulfate; and inorganic metal salt polymers, such as polyaluminum chloride, polyaluminum hydroxide, and calcium polysulfide.

The chelating agent may be a water-soluble chelating agent. Examples of such a chelating agent include oxycarboxylic acids, such as tartaric acid, citric acid, and gluconic acid; and iminodiacetic acid (IDA), nitrilotriacetic acid (NTA), and ethylenediaminetetraacetic acid (EDTA).

The amount of the chelating agent used is, for example, preferably 0.01 parts by mass or more and 5.0 parts by mass or less and is more preferably 0.1 parts by mass or more and less than 3.0 parts by mass relative to 100 parts by mass of the resin particles.

### Fusion Coalescence Step

The aggregated particle dispersion liquid in which the aggregated particles are dispersed is heated to, for example, a temperature equal to or higher than the glass transition temperature of the binder resin particles (e.g., [Glass transition temperature of the resin particles+10° C.] or more and [the Glass transition temperature+30° C.] or less) in order to perform fusion and coalescence of the aggregated particles and form toner particles.

The toner particles are produced through the above-described steps.

The toner particles may be produced by, subsequent to the preparation of the aggregated particle dispersion liquid in which the aggregated particles are dispersed, mixing the aggregated particle dispersion liquid with a resin particle dispersion liquid in which resin particles are dispersed and another resin particle dispersion liquid in which other resin particles are dispersed and causing aggregation such that the resin particles and the other resin particles are adhered onto the surfaces of the aggregated particles to form second aggregated particles; and heating a second aggregated particle dispersion liquid in which the second aggregated particles are dispersed to cause fusion and coalescence of the second aggregated particles and form toner particles having a core-shell structure.

In the step of forming the second aggregated particles, the addition of the resin particle dispersion liquid and the adhesion of the resin particles onto the surfaces of the aggregated particles may be repeated a plurality of times.

After the completion of the fusion-coalescence step, the toner particles formed in the solution are subjected to any suitable cleaning step, solid-liquid separation step, and drying step that are known in the related art in order to obtain dried toner particles.

In the cleaning step, the toner particles may be subjected to displacement washing using ion-exchange water to a sufficient degree from the viewpoint of electrification characteristics. Examples of a solid-liquid separation method used in the solid-liquid separation step include, but are not limited to, suction filtration and pressure filtration from the viewpoint of productivity. Examples of a drying method used in the drying step include, but are not limited to, freeze-drying, flash drying, fluidized drying, and vibrating fluidized drying from the viewpoint of productivity.

The toner according to the exemplary embodiment is produced by, for example, adding an external additive to the dried toner particles and mixing the resulting toner particles using a V-blender, a HENSCHEL mixer, a Lodige mixer, or the like. Optionally, coarse toner particles may be removed using a vibrating screen classifier, a wind screen classifier, or the like.

### Electrostatic Image Developer

An electrostatic image developer according to the exemplary embodiment includes at least the toner according to the exemplary embodiment or the toner according to the second exemplary embodiment.

The electrostatic image developer according to the exemplary embodiment may be a single component developer including only the toner according to the exemplary embodiment or the toner according to the second exemplary embodiment or may be a two-component developer that is a mixture of the toner and a carrier.

The type of the carrier is not limited, and any suitable carrier known in the related art may be used. Examples of the carrier include a coated carrier prepared by coating the surfaces of cores including magnetic powder particles with a resin; a magnetic-powder-dispersed carrier prepared by dispersing and mixing magnetic powder particles in a matrix resin; and a resin-impregnated carrier prepared by impregnating a porous magnetic powder with a resin.

The magnetic-powder-dispersed carrier and the resin-impregnated carrier may also be prepared by coating the surfaces of particles constituting the carrier, that is, core particles, with a resin.

Examples of the magnetic powder include powders of magnetic metals, such as iron, nickel, and cobalt; and powders of magnetic oxides, such as ferrite and magnetite.

Examples of the coat resin and the matrix resin include polyethylene, polypropylene, polystyrene, poly(vinyl acetate), poly(vinyl alcohol), poly(vinyl butyral), poly(vinyl chloride), poly(vinyl ether), poly(vinyl ketone), a vinyl chloride-vinyl acetate copolymer, a styrene-acrylic acid ester copolymer, a straight silicone resin including an organosiloxane bond and the modified products thereof, a fluorine resin, polyester, polycarbonate, a phenolic resin, and an epoxy resin.

The coat resin and the matrix resin may optionally include additives, such as conductive particles.

Examples of the conductive particles include particles of metals, such as gold, silver, and copper; and particles of carbon black, titanium oxide, zinc oxide, tin oxide, barium sulfate, aluminum borate, and potassium titanate.

The surfaces of the cores can be coated with a resin by, for example, using a coating-layer forming solution prepared by dissolving the coat resin and, as needed, various types of additives in a suitable solvent. The type of the solvent is not limited and may be selected with consideration of the type of the resin used, ease of applying the coating-layer forming solution, and the like.

Specific examples of a method for coating the surfaces of the cores with the coat resin include an immersion method in which the cores are immersed in the coating-layer forming solution; a spray method in which the coating-layer forming solution is sprayed onto the surfaces of the cores; a fluidized-bed method in which the coating-layer forming solution is sprayed onto the surfaces of the cores while the cores are floated using flowing air; and a kneader-coater method in which the cores of the carrier are mixed with the coating-layer forming solution in a kneader coater and subsequently the solvent is removed.

The mixing ratio (i.e., mass ratio) of the toner to the carrier in the two-component developer is preferably toner:carrier=1:100 to 30:100 and is more preferably 3:100 to 20:100.

### Image Forming Apparatus and Image Forming Method

An image forming apparatus and an image forming method according to the exemplary embodiment are described below.

The image forming apparatus according to the exemplary embodiment includes an image holding member; a charging unit that charges the surface of the image holding member; an electrostatic image formation unit that forms an electrostatic image on the charged surface of the image holding member; a developing unit that includes an electrostatic image developer and develops the electrostatic image formed on the surface of the image holding member with the electrostatic image developer to form a toner image; a transfer unit that transfers the toner image formed on the surface of the image holding member onto the surface of a recording medium; and a fixing unit that fixes the toner image onto the surface of the recording medium. The electrostatic image developer is the electrostatic image developer according to the exemplary embodiment.

The image forming apparatus according to the exemplary embodiment uses an image forming method (image forming method according to the exemplary embodiment) including charging the surface of the image holding member; forming an electrostatic image on the charged surface of the image holding member; developing the electrostatic image formed on the surface of the image holding member with the electrostatic image developer according to the exemplary embodiment to form a toner image; transferring the toner image formed on the surface of the image holding member onto the surface of a recording medium; and fixing the toner image onto the surface of the recording medium.

The image forming apparatus according to the exemplary embodiment may be any image forming apparatus known in the related art, such as a direct-transfer image forming apparatus in which a toner image formed on the surface of an image holding member is directly transferred to a recording medium; an intermediate-transfer image forming apparatus in which a toner image formed on the surface of an image holding member is transferred onto the surface of an intermediate transfer body in the first transfer step and the toner image transferred on the surface of the intermediate transfer body is transferred onto the surface of a recording medium in the second transfer step; an image forming apparatus including a cleaning unit that cleans the surface of the image holding member subsequent to the transfer of the toner image before the image holding member is again charged; and an image forming apparatus including a static-erasing unit that erases static by irradiating the surface of an image holding member with static-erasing light subsequent to the transfer of the toner image before the image holding member is again charged.

In the case where the image forming apparatus according to this exemplary embodiment is the intermediate-transfer image forming apparatus, the transfer unit may be constituted by, for example, an intermediate transfer body to which a toner image is transferred, a first transfer subunit that transfers a toner image formed on the surface of the image holding member onto the surface of the intermediate transfer body in the first transfer step, and a second transfer subunit that transfers the toner image transferred on the surface of the intermediate transfer body onto the surface of a recording medium in the second transfer step.

In the image forming apparatus according to the exemplary embodiment, for example, a portion including the developing unit may have a cartridge structure (i.e., process cartridge) detachably attachable to the image forming apparatus. An example of the process cartridge is a process cartridge including the electrostatic image developer according to the exemplary embodiment and the developing unit.

An example of the image forming apparatus according to the exemplary embodiment is described below, but the image forming apparatus is not limited thereto. Hereinafter, only components illustrated in drawings are described; others are omitted.

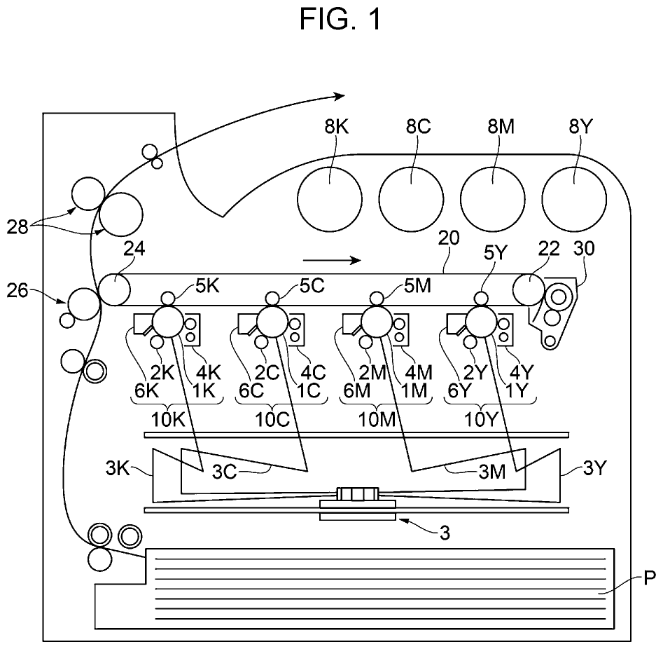

FIG. 1 schematically illustrates the image forming apparatus according to the exemplary embodiment.

The image forming apparatus illustrated in FIG. 1 includes first to fourth electrophotographic image formation units 10Y, 10M, 10C, and 10K that form yellow (Y), magenta (M), cyan (C), and black (K) images, respectively, on the basis of color separation image data. The image formation units (hereinafter, referred to simply as “units”) 10Y, 10M, 10C, and 10K are horizontally arranged in parallel at a predetermined distance from one another. The units 10Y, 10M, 10C, and 10K may be process cartridges detachably attachable to the image forming apparatus.

An intermediate transfer belt (an example of the intermediate transfer body) 20 runs above and extends over the units 10Y, 10M, 10C, and 10K so as to pass through the units. The intermediate transfer belt 20 is wound around a drive roller 22 and a support roller 24 arranged to contact with the inner surface of the intermediate transfer belt 20 and runs in the direction from the first unit 10Y to the fourth unit 10K. Using a spring or the like (not illustrated), a force is applied to the support roller 24 in a direction away from the drive roller 22, thereby applying tension to the intermediate transfer belt 20 wound around the drive roller 22 and the support roller 24. An intermediate transfer belt-cleaning device 30 is disposed so as to contact with the image holding member-side surface of the intermediate transfer belt 20 and to face the drive roller 22.

Developing devices (i.e., examples of developing units) 4Y, 4M, 4C, and 4K of the units 10Y, 10M, 10C, and 10K are supplied with yellow, magenta, cyan, and black toners stored in toner cartridges 8Y, 8M, 8C, and 8K, respectively.

Since the first to fourth units 10Y, 10M, 10C, and 10K have the same structure and the same action, the following description is made with reference to, as a representative, the first unit 10Y that forms an yellow image and is located upstream in a direction in which the intermediate transfer belt runs.

The first unit 10Y includes a photosensitive member 1Y serving as an image holding member. The following components are disposed around the photosensitive member 1Y sequentially in the counterclockwise direction: a charging roller (example of the charging unit) 2Y that charges the surface of the photosensitive member 1Y at a predetermined potential; an exposure device (example of the electrostatic image formation unit) 3 that forms an electrostatic image by irradiating the charged surface of the photosensitive member 1Y with a laser beam 3Y based on a color separated image signal; a developing device (example of the developing unit) 4Y that develops the electrostatic image by supplying a charged toner to the electrostatic image; a first transfer roller (example of the first transfer subunit) 5Y that transfers the developed toner image to the intermediate transfer belt 20; and a photosensitive-member cleaning device (example of the image holding member-cleaning unit) 6Y that removes a toner remaining on the surface of the photosensitive member 1Y after the first transfer.

The first transfer roller 5Y is disposed so as to contact with the inner surface of the intermediate transfer belt 20 and to face the photosensitive member 1Y. Each of the first transfer rollers 5Y, 5M, 5C, and 5K of the respective units is connected to a bias power supply (not illustrated) that applies a first transfer bias to the first transfer rollers. Each bias power supply varies the transfer bias applied to the corresponding first transfer roller on the basis of the control by a controller (not illustrated).

The action of forming a yellow image in the first unit 10Y is described below.

Before the action starts, the surface of the photosensitive member 1Y is charged at a potential of −600 to −800 V by the charging roller 2Y.

The photosensitive member 1Y is formed by stacking a photosensitive layer on a conductive substrate (e.g., volume resistivity at 20° C.: 1×10⁻⁶ Ωcm or less). The photosensitive layer is normally of high resistance (comparable with the resistance of ordinary resins), but, upon being irradiated with the laser beam, the specific resistance of the portion irradiated with the laser beam varies. Thus, the exposure device 3 irradiates the surface of the charged photosensitive member 1Y with the laser beam 3Y on the basis of the image data of the yellow image sent from the controller (not illustrated). As a result, an electrostatic image of yellow image pattern is formed on the surface of the photosensitive member 1Y.

The term “electrostatic image” used herein refers to an image formed on the surface of the photosensitive member 1Y by charging, the image being a “negative latent image” formed by irradiating a portion of the photosensitive layer with the laser beam 3Y to reduce the specific resistance of the irradiated portion such that the charges on the irradiated surface of the photosensitive member 1Y discharge while the charges on the portion that is not irradiated with the laser beam 3Y remain.

The electrostatic image, which is formed on the photosensitive member 1Y as described above, is sent to the predetermined developing position by the rotating photosensitive member 1Y. The electrostatic image on the photosensitive member 1Y is developed and visualized in the form of a toner image by the developing device 4Y at the developing position.

The developing device 4Y includes an electrostatic image developer including, for example, at least, a yellow toner and a carrier. The yellow toner is stirred in the developing device 4Y to be charged by friction and supported on a developer roller (example of the developer support), carrying an electric charge of the same polarity (i.e., negative) as the electric charge generated on the photosensitive member 1Y. The yellow toner is electrostatically adhered to the erased latent image portion on the surface of the photosensitive member 1Y as the surface of the photosensitive member 1Y passes through the developing device 4Y. Thus, the latent image is developed using the yellow toner. The photosensitive member 1Y on which the yellow toner image is formed keeps rotating at the predetermined rate, thereby transporting the toner image developed on the photosensitive member 1Y to the predetermined first transfer position.

Upon the yellow toner image on the photosensitive member 1Y reaching the first transfer position, first transfer bias is applied to the first transfer roller 5Y so as to generate an electrostatic force on the toner image in the direction from the photosensitive member 1Y toward the first transfer roller 5Y. Thus, the toner image on the photosensitive member 1Y is transferred to the intermediate transfer belt 20. The transfer bias applied has the opposite polarity (+) to that of the toner (−) and controlled to be, for example, in the first unit 10Y, +10 μA by a controller (not illustrated).

The toner particles remaining on the photosensitive member 1Y are removed by the photosensitive-member cleaning device 6Y and then collected.

Each of the first transfer biases applied to first transfer rollers 5M, 5C, and 5K of the second, third, and fourth units 10M, 10C, and 10K is controlled in accordance with the first unit 10Y.

Thus, the intermediate transfer belt 20, on which the yellow toner image is transferred in the first unit 10Y, is successively transported through the second to fourth units 10M, 10C, and 10K while toner images of the respective colors are stacked on top of another.

The resulting intermediate transfer belt 20 on which toner images of four colors are multiple-transferred in the first to fourth units is then transported to a second transfer section including a support roller 24 contacting with the inner surface of the intermediate transfer belt 20 and a second transfer roller (example of the second transfer subunit) 26 disposed on the image-carrier-side of the intermediate transfer belt 20. A recording paper (example of the recording medium) P is fed by a feed mechanism into a narrow space between the second transfer roller 26 and the intermediate transfer belt 20 that contact with each other at the predetermined timing. The second transfer bias is then applied to the support roller 24. The transfer bias applied here has the same polarity (−) as that of the toner (−) and generates an electrostatic force on the toner image in the direction from the intermediate transfer belt 20 toward the recording paper P. Thus, the toner image on the intermediate transfer belt 20 is transferred to the recording paper P. The intensity of the second transfer bias applied is determined on the basis of the resistance of the second transfer section which is detected by a resistance detector (not illustrated) that detects the resistance of the second transfer section and controlled by changing voltage.

The recording paper P on which the toner image is transferred is transported into a nip part of the fixing device (example of the fixing unit) 28 at which a pair of fixing rollers contact with each other. The toner image is fixed to the recording paper P to form a fixed image. The recording paper P, to which the color image has been fixed, is transported toward an exit portion. Thus, the series of the steps for forming a color image are terminated.

Examples of the recording paper P to which a toner image is transferred include plain paper used in electrophotographic copiers, printers, and the like. Instead of the recording paper P, OHP films and the like may be used as a recording medium.

The surface of the recording paper P may be smooth in order to enhance the smoothness of the surface of the fixed image. Examples of such a recording paper include coated paper produced by coating the surface of plain paper with resin or the like and art paper for printing.

### Process Cartridge and Toner Cartridge

A process cartridge according to the exemplary embodiment is described below.

The process cartridge according to the exemplary embodiment includes a developing unit that includes the electrostatic image developer according to the exemplary embodiment and develops an electrostatic image formed on the surface of an image holding member with the electrostatic image developer to form a toner image. The process cartridge according to the exemplary embodiment is detachably attachable to an image forming apparatus.

The process cartridge according to the exemplary embodiment may further include, in addition to the developing unit, at least one unit selected from an image holding member, a charging unit, an electrostatic image formation unit, a transfer unit, etc.

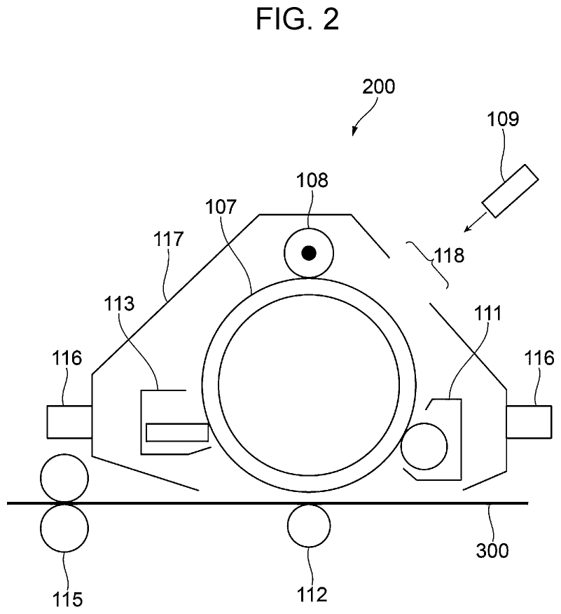

An example of the process cartridge according to the exemplary embodiment is described below, but the process cartridge is not limited thereto. Hereinafter, only components illustrated in FIG. 2 are described; others are omitted.

FIG. 2 schematically illustrates an example of the process cartridge according to the exemplary embodiment.

A process cartridge 200 illustrated in FIG. 2 includes, for example, a photosensitive member 107 (example of the image holding member), a charging roller 108 (example of the charging unit) disposed on the periphery of the photosensitive member 107, a developing device 111 (example of the developing unit), and a photosensitive-member cleaning device 113 (example of the cleaning unit), which are combined into one unit using a housing 117 to form a cartridge. The housing 117 has an aperture 118 for exposure. A mounting rail 116 is disposed on the housing 117.

In FIG. 2, Reference numeral 109 denotes an exposure device (example of the electrostatic image formation unit), Reference numeral 112 denotes a transfer device (example of the transfer unit), Reference numeral 115 denotes a fixing device (example of the fixing unit), and the Reference numeral 300 denotes recording paper (example of the recording medium).

A toner cartridge according to the exemplary embodiment is described below.

The toner cartridge according to the exemplary embodiment is a toner cartridge that includes the toner according to the exemplary embodiment and is detachably attachable to an image forming apparatus. The toner cartridge includes a replenishment toner that is to be supplied to the developing unit disposed inside an image forming apparatus.

The image forming apparatus illustrated in FIG. 1 is an image forming apparatus that includes the toner cartridges 8Y, 8M, 8C, and 8K detachably attached to the image forming apparatus. Each of the developing devices 4Y, 4M, 4C, and 4K is connected to a specific one of the toner cartridges which corresponds to the color of the developing device with a toner supply pipe (not illustrated). When the amount of toner contained in a toner cartridge is small, the toner cartridge is replaced.

### EXAMPLES

Details of the exemplary embodiments of the present disclosure are described with reference to Examples below. It should be noted that the exemplary embodiments of the present disclosure are not limited by Examples. Hereinafter, all “part” and “%” are on a mass basis unless otherwise specified.

### Preparation of Emulsions (1-1) to (1-4)

### Emulsion (1-1)

Styrene: 40 parts
n-Butyl acrylate: 58.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (1-1).

### Emulsion (1-2)

Styrene: 45 parts
n-Butyl acrylate: 53.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (1-2).

### Emulsion (1-3)

Styrene: 55 parts
n-Butyl acrylate: 43.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (1-3).

### Emulsion (1-4)

Styrene: 60 parts
n-Butyl acrylate: 38.5 parts
1,10-Decanediol diacrylate: 1.5 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (1-4).

### Preparation of Styrene-(Meth)Acrylate Copolymer Particle Dispersion Liquid (1)

After the inside of a reactor equipped with a stirring device and a nitrogen introduction tube has been purged with nitrogen, 1.1 parts of an anionic surfactant (ELEMINOL MON-2) and 400 parts of ion-exchange water are added to the reactor. While being stirred, the resulting reaction solution is heated in an oil bath until the temperature of the reaction solution reaches 75° C. After 10 parts of the emulsion (1-1) has been added to the solution, 20 parts of an aqueous ammonium persulfate solution the concentration of which has been adjusted to 10% by mass is added to the solution. Subsequently, holding is performed for 30 minutes.

While the temperature of the reaction solution is maintained at 75° C., 190 parts of the emulsion (1-1) is gradually added dropwise to the reactor with a pump over 30 minutes. Then, 200 parts of the emulsion (1-2) is added dropwise to the reactor over 30 minutes. Subsequently, 200 parts of the emulsion (1-3) is added dropwise to the reactor over 40 minutes. Furthermore, 200 parts of the emulsion (1-4) is added dropwise to the reactor over 40 minutes.

Subsequent to the addition of the emulsions, holding is performed for 60 minutes. Then, 2 parts of ammonium persulfate having a concentration of 10% by mass is added to the reactor. After holding has been performed for another 3 hours, the temperature is reduced to room temperature. Subsequently, ion-exchange water and nitric acid are added to the reactor such that the solid content concentration reaches 20% by mass. Hereby, a styrene-(meth)acrylate copolymer particle dispersion liquid (1) is prepared.

The resulting resin particles have a volume average size of 165 nm. The glass transition temperature measured with a differential scanning calorimeter is 17° C.

### Preparation of Styrene-(Meth)Acrylate Copolymer Particle Dispersion Liquid (2)

### Preparation of Emulsions (2-1) to (2-4)

### Emulsion (2-1)

Styrene: 48 parts
n-Butyl acrylate: 50.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (2-1).

### Emulsion (2-2)

Styrene: 49 parts
n-Butyl acrylate: 49.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (2-2).

### Emulsion (2-3)

Styrene: 50 parts
n-Butyl acrylate: 48.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (2-3).

### Emulsion (2-4)

Styrene: 53 parts
n-Butyl acrylate: 45.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (2-4).

A styrene-(meth)acrylate copolymer particle dispersion liquid (2) is prepared as in the preparation of the styrene-(meth)acrylate copolymer particle dispersion liquid (1), except that the emulsions (1-1), (1-2), (1-3), and (1-4) are replaced with the emulsions (2-1), (2-2), (2-3), and (2-4), respectively.

The resulting resin particles have a volume average size of 160 nm. The glass transition temperature measured with a differential scanning calorimeter is 9° C.

### Preparation of Styrene-(Meth)Acrylate Copolymer Particle Dispersion Liquid (3)

### Preparation of Emulsions (3-1) to (3-4)

### Emulsion (3-1)

Styrene: 47 parts
n-Butyl acrylate: 51.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (3-1).

### Emulsion (3-2)

Styrene: 49 parts
n-Butyl acrylate: 49.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (3-2).

### Emulsion (3-3)

Styrene: 51 parts
n-Butyl acrylate: 47.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (3-3).

### Emulsion (3-4)

Styrene: 53 parts
n-Butyl acrylate: 45.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (3-4).

A styrene-(meth)acrylate copolymer particle dispersion liquid (3) is prepared as in the preparation of the styrene-(meth)acrylate copolymer particle dispersion liquid (1), except that the emulsions (1-1), (1-2), (1-3), and (1-4) are replaced with the emulsions (3-1), (3-2), (3-3), and (3-4), respectively.

The resulting resin particles have a volume average size of 165 nm. The glass transition temperature measured with a differential scanning calorimeter is 12° C.

### Preparation of Styrene-(Meth)Acrylate Copolymer Particle Dispersion Liquid (4)

### Preparation of Emulsions (4-1) to (4-4)

### Emulsion (4-1)

Styrene: 37 parts
n-Butyl acrylate: 61.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (4-1).

### Emulsion (4-2)

Styrene: 48 parts
n-Butyl acrylate: 50.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (4-2).

### Emulsion (4-3)

Styrene: 55 parts
n-Butyl acrylate: 43.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (4-3).

### Emulsion (4-4)

Styrene: 60 parts
n-Butyl acrylate: 38.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (4-4).

A styrene-(meth)acrylate copolymer particle dispersion liquid (4) is prepared as in the preparation of the styrene-(meth)acrylate copolymer particle dispersion liquid (1), except that the emulsions (1-1), (1-2), (1-3), and (1-4) are replaced with the emulsions (4-1), (4-2), (4-3), and (4-4), respectively.

The resulting resin particles have a volume average size of 170 nm. The glass transition temperature measured with a differential scanning calorimeter is 20° C.

### Preparation of Styrene-(Meth)Acrylate Copolymer Particle Dispersion Liquid (5)

### Preparation of Emulsions (5-1) to (5-4)

### Emulsion (5-1)

Styrene: 34 parts
n-Butyl acrylate: 64.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (5-1).

### Emulsion (5-2)

Styrene: 48 parts
n-Butyl acrylate: 50.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (5-2).

### Emulsion (5-3)

Styrene: 58 parts
n-Butyl acrylate: 40.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (5-3).

### Emulsion (5-4)

Styrene: 60 parts
n-Butyl acrylate: 38.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (5-4).

A styrene-(meth)acrylate copolymer particle dispersion liquid (5) is prepared as in the preparation of the styrene-(meth)acrylate copolymer particle dispersion liquid (1), except that the emulsions (1-1), (1-2), (1-3), and (1-4) are replaced with the emulsions (5-1), (5-2), (5-3), and (5-4), respectively.

The resulting resin particles have a volume average size of 175 nm. The glass transition temperature measured with a differential scanning calorimeter is 22° C.

### Preparation of Styrene-(Meth)Acrylate Copolymer Particle Dispersion Liquid (6)

### Preparation of Emulsions (6-1) to (6-4)

### Emulsion (6-1)

Styrene: 42 parts
n-Butyl acrylate: 56.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (6-1).

### Emulsion (6-2)

Styrene: 51 parts
n-Butyl acrylate: 47.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (6-2).

### Emulsion (6-3)

Styrene: 52 parts
n-Butyl acrylate: 46.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (6-3).

### Emulsion (6-4)

Styrene: 53 parts
n-Butyl acrylate: 45.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (6-4).

A styrene-(meth)acrylate copolymer particle dispersion liquid (6) is prepared as in the preparation of the styrene-(meth)acrylate copolymer particle dispersion liquid (1), except that the emulsions (1-1), (1-2), (1-3), and (1-4) are replaced with the emulsions (6-1), (6-2), (6-3), and (6-4), respectively.

The resulting resin particles have a volume average size of 180 nm. The glass transition temperature measured with a differential scanning calorimeter is 15° C.

### Preparation of Styrene-(Meth)Acrylate Copolymer Particle Dispersion Liquid (7)

### Preparation of Emulsions (7-1) and (7-2)

### Emulsion (7-1)

Styrene: 49 parts
n-Butyl acrylate: 49.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (7-1).

### Emulsion (7-2)

Styrene: 156 parts
n-Butyl acrylate: 139.5 parts
1,10-Decanediol diacrylate: 4.5 parts
Anionic surfactant (“ELEMINOL MON-2” produced by Sanyo Chemical Industries, Ltd.): 3.6 parts
Ion-exchange water: 296.4 parts

The above materials are charged into a mixing container equipped with a stirring device and the resulting mixture is stirred to form an emulsion (7-2).

After the inside of a reactor equipped with a stirring device and a nitrogen introduction tube has been purged with nitrogen, 1.1 parts of an anionic surfactant (ELEMINOL MON-2) and 400 parts of ion-exchange water are added to the reactor. While being stirred, the resulting reaction solution is heated in an oil bath until the temperature of the reaction solution reaches 70° C. After 10 parts of the emulsion (7-1) has been added to the solution, 20 parts of an aqueous ammonium persulfate solution the concentration of which has been adjusted to 10% by mass is added to the solution. Subsequently, holding is performed for 30 minutes.

While the temperature of the reaction solution is maintained at 65° C., 190 parts of the emulsion (7-1) is gradually added dropwise to the reactor with a pump over 30 minutes. Then, 600 parts of the emulsion (7-2) is added dropwise to the reactor over 100 minutes.

Subsequent to the addition of the emulsions, holding is performed for 60 minutes. Then, 2 parts of ammonium persulfate having a concentration of 10% by mass is added to the reactor. After holding has been performed for another 3 hours, the temperature is reduced to room temperature. Subsequently, ion-exchange water and nitric acid are added to the reactor such that the solid content concentration reaches 20% by mass. Hereby, a styrene-(meth)acrylate copolymer particle dispersion liquid (7) is prepared.

The resulting resin particles have a volume average size of 170 nm. The glass transition temperature measured with a differential scanning calorimeter is 7° C.

### Preparation of Styrene-(Meth)Acrylate Copolymer Particle Dispersion Liquid (8)

### Preparation of Emulsions (8-1) to (8-4)

### Emulsion (8-1)

Styrene: 32 parts
Ethyl acrylate: 66.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (8-1).

### Emulsion (8-2)

Styrene: 34 parts
Ethyl acrylate: 64.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (8-2).

### Emulsion (8-3)

Styrene: 36 parts
Ethyl acrylate: 62.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (8-3).

### Emulsion (8-4)

Styrene: 41.5 parts
Ethyl acrylate: 57 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (8-4).

A styrene-(meth)acrylate copolymer particle dispersion liquid (8) is prepared as in the preparation of the styrene-(meth)acrylate copolymer particle dispersion liquid (1), except that the emulsions (1-1), (1-2), (1-3), and (1-4) are replaced with the emulsions (8-1), (8-2), (8-3), and (8-4), respectively.

The resulting resin particles have a volume average size of 165 nm. The glass transition temperature measured with a differential scanning calorimeter is 22° C.

### Preparation of Styrene-(Meth)Acrylate Copolymer Particle Dispersion Liquid (9)

### Preparation of Emulsions (9-1) to (9-4)

### Emulsion (9-1)

Styrene: 32 parts
Ethyl acrylate: 66.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (9-1).

### Emulsion (9-2)

Styrene: 33 parts
Ethyl acrylate: 65.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (9-2).

### Emulsion (9-3)

Styrene: 35 parts
Ethyl acrylate: 63.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (9-3).

### Emulsion (9-4)

Styrene: 46 parts
Ethyl acrylate: 52.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (9-4).

A styrene-(meth)acrylate copolymer particle dispersion liquid (9) is prepared as in the preparation of the styrene-(meth)acrylate copolymer particle dispersion liquid (1), except that the emulsions (1-1), (1-2), (1-3), and (1-4) are replaced with the emulsions (9-1), (9-2), (9-3), and (9-4), respectively.

The resulting resin particles have a volume average size of 160 nm. The glass transition temperature measured with a differential scanning calorimeter is 25° C.

### Preparation of Styrene-(Meth)Acrylate Copolymer Particle Dispersion Liquid (10)

### Preparation of Emulsions (10-1) to (10-4)

### Emulsion (10-1)

Styrene: 50 parts
2-Ethylhexyl acrylate: 48.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (10-1).

### Emulsion (10-2)

Styrene: 52 parts
2-Ethylhexyl acrylate: 46.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (10-2).

### Emulsion (10-3)

Styrene: 55 parts
2-Ethylhexyl acrylate: 43.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (10-3).

### Emulsion (10-4)

Styrene: 61 parts
2-Ethylhexyl acrylate: 37.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (10-4).

A styrene-(meth)acrylate copolymer particle dispersion liquid (10) is prepared as in the preparation of the styrene-(meth)acrylate copolymer particle dispersion liquid (1), except that the emulsions (1-1), (1-2), (1-3), and (1-4) are replaced with the emulsions (10-1), (10-2), (10-3), and (10-4), respectively.

The resulting resin particles have a volume average size of 155 nm. The glass transition temperature measured with a differential scanning calorimeter is 9° C.

### Preparation of Styrene-(Meth)Acrylate Copolymer Particle Dispersion Liquid (11)

### Preparation of Emulsions (11-1) to (11-4)

### Emulsion (11-1)

Styrene: 50 parts
2-Ethylhexyl acrylate: 48.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (11-1).

### Emulsion (11-2)

Styrene: 52 parts
2-Ethylhexyl acrylate: 46.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (11-2).

### Emulsion (11-3)

Styrene: 55 parts
2-Ethylhexyl acrylate: 43.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (11-3).

### Emulsion (11-4)

Styrene: 67 parts
2-Ethylhexyl acrylate: 31.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (11-4).

A styrene-(meth)acrylate copolymer particle dispersion liquid (11) is prepared as in the preparation of the styrene-(meth)acrylate copolymer particle dispersion liquid (1), except that the emulsions (1-1), (1-2), (1-3), and (1-4) are replaced with the emulsions (11-1), (11-2), (11-3), and (11-4), respectively.

The resulting resin particles have a volume average size of 150 nm. The glass transition temperature measured with a differential scanning calorimeter is 14° C.

### Preparation of Styrene-(Meth)Acrylate Copolymer Particle Dispersion Liquid (12)

### Preparation of Emulsions (12-1) to (12-4)

### Emulsion (12-1)

Styrene: 42 parts
n-Butyl acrylate: 56.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (12-1).

### Emulsion (12-2)

Styrene: 43.5 parts
n-Butyl acrylate: 55 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (12-2).

### Emulsion (12-3)

Styrene: 45 parts
n-Butyl acrylate: 53.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (12-3).

### Emulsion (12-4)

Styrene: 70 parts
n-Butyl acrylate: 28.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (12-4).

A styrene-(meth)acrylate copolymer particle dispersion liquid (12) is prepared as in the preparation of the styrene-(meth)acrylate copolymer particle dispersion liquid (1), except that the emulsions (1-1), (1-2), (1-3), and (1-4) are replaced with the emulsions (12-1), (12-2), (12-3), and (12-4), respectively.

The resulting resin particles have a volume average size of 170 nm. The glass transition temperature measured with a differential scanning calorimeter is 19° C.

### Preparation of Styrene-(Meth)Acrylate Copolymer Particle Dispersion Liquid (13)

### Preparation of Emulsions (13-1) to (13-4)

### Emulsion (13-1)

Styrene: 40 parts
2-Ethylhexyl acrylate: 58.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (13-1).

### Emulsion (13-2)

Styrene: 43 parts
2-Ethylhexyl acrylate: 55.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (13-2).

### Emulsion (13-3)

Styrene: 46 parts
2-Ethylhexyl acrylate: 52.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (13-3).

### Emulsion (13-4)

Styrene: 52 parts
2-Ethylhexyl acrylate: 46.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (13-4).

A styrene-(meth)acrylate copolymer particle dispersion liquid (13) is prepared as in the preparation of the styrene-(meth)acrylate copolymer particle dispersion liquid (1), except that the emulsions (1-1), (1-2), (1-3), and (1-4) are replaced with the emulsions (13-1), (13-2), (13-3), and (13-4), respectively.

The resulting resin particles have a volume average size of 175 nm. The glass transition temperature measured with a differential scanning calorimeter is −1° C.

### Preparation of Styrene-(Meth)Acrylate Copolymer Particle Dispersion Liquid (14)

### Preparation of Emulsions (14-1) to (14-4)

### Emulsion (14-1)

Styrene: 32 parts
Ethyl acrylate: 66.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (14-1).

### Emulsion (14-2)

Styrene: 34 parts
Ethyl acrylate: 64.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (14-2).

### Emulsion (14-3)

Styrene: 39 parts
Ethyl acrylate: 59.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (14-3).

### Emulsion (14-4)

Styrene: 48.5 parts
Ethyl acrylate: 50 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (14-4).

A styrene-(meth)acrylate copolymer particle dispersion liquid (14) is prepared as in the preparation of the styrene-(meth)acrylate copolymer particle dispersion liquid (1), except that the emulsions (1-1), (1-2), (1-3), and (1-4) are replaced with the emulsions (14-1), (14-2), (14-3), and (14-4), respectively.

The resulting resin particles have a volume average size of 170 nm. The glass transition temperature measured with a differential scanning calorimeter is 31° C.

Preparation of Styrene-(Meth)Acrylate Copolymer Particle Dispersion Liquid (15) A styrene-(meth)acrylate copolymer particle dispersion liquid (15) is prepared as in the preparation of the styrene-(meth)acrylate copolymer particle dispersion liquid (1), except that the amount of the anionic surfactant (ELEMINOL MON-2) added to the reactor is changed from 1.1 parts to 3.5 parts.

The resulting resin particles have a volume average size of 45 nm. The glass transition temperature measured with a differential scanning calorimeter is 17° C.

### Preparation of Styrene-(Meth)Acrylate Copolymer Particle Dispersion Liquid (16)

A styrene-(meth)acrylate copolymer particle dispersion liquid (16) is prepared as in the preparation of the styrene-(meth)acrylate copolymer particle dispersion liquid (1), except that the amount of the anionic surfactant (ELEMINOL MON-2) added to the reactor is changed from 1.1 parts to 0.2 parts.

The resulting resin particles have a volume average size of 310 nm. The glass transition temperature measured with a differential scanning calorimeter is 17° C.

### Preparation of Styrene-(Meth)Acrylate Copolymer Particle Dispersion Liquid (17)

### Preparation of Emulsions (17-1) to (17-4)

### Emulsion (17-1)

Styrene: 40 parts
n-Butyl acrylate: 58 parts
1,10-Decanediol diacrylate: 2 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (17-1).

### Emulsion (17-2)

Styrene: 45 parts
n-Butyl acrylate: 53.2 parts
1,10-Decanediol diacrylate: 1.8 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (17-2).

### Emulsion (17-3)

Styrene: 55 parts
n-Butyl acrylate: 43.6 parts
1,10-Decanediol diacrylate: 1.4 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (17-3).

### Emulsion (17-4)

Styrene: 60 parts
n-Butyl acrylate: 39.2 parts
1,10-Decanediol diacrylate: 0.8 parts
Anionic surfactant (“ELEMINOL MON-2”): 1.2 parts
Ion-exchange water: 98.8 parts

The above materials are charged into a mixing container equipped with a stirring device and the resulting mixture is stirred to form an emulsion (17-4).

A styrene-(meth)acrylate copolymer particle dispersion liquid (17) is prepared as in the preparation of the styrene-(meth)acrylate copolymer particle dispersion liquid (1), except that the emulsions (1-1), (1-2), (1-3), and (1-4) are replaced with the emulsions (17-1), (17-2), (17-3), and (17-4), respectively.

The resulting resin particles have a volume average size of 195 nm. The glass transition temperature measured with a differential scanning calorimeter is 17° C.

### Preparation of Styrene-(Meth)Acrylate Copolymer Particle Dispersion Liquid (18)

### Preparation of Emulsions (18-1) to (18-4)

### Emulsion (18-1)

Styrene: 34 parts
2-Ethylhexyl acrylate: 64.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (18-1).

### Emulsion (18-2)

Styrene: 40 parts
2-Ethylhexyl acrylate: 58.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (18-2).

### Emulsion (18-3)

Styrene: 47 parts
2-Ethylhexyl acrylate: 51.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (18-3).

### Emulsion (18-4)

Styrene: 55 parts
2-Ethylhexyl acrylate: 43.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (18-4).

A styrene-(meth)acrylate copolymer particle dispersion liquid (18) is prepared as in the preparation of the styrene-(meth)acrylate copolymer particle dispersion liquid (1), except that the emulsions (1-1), (1-2), (1-3), and (1-4) are replaced with the emulsions (18-1), (18-2), (18-3), and (18-4), respectively.

The resulting resin particles have a volume average size of 160 nm. The glass transition temperature measured with a differential scanning calorimeter is 1° C.

### Preparation of Styrene-(Meth)Acrylate Copolymer Particle Dispersion Liquid (19)

### Emulsion (19)

Styrene: 200 parts
n-Butyl acrylate: 194 parts
1,10-Decanediol diacrylate: 6 parts
Anionic surfactant (“ELEMINOL MON-2”): 5 parts
Ion-exchange water: 395 parts

The above materials are charged into a mixing container equipped with a stirring device and the resulting mixture is stirred to form an emulsion (19).

After the inside of a reactor equipped with a stirring device and a nitrogen introduction tube has been purged with nitrogen, 1.1 parts of an anionic surfactant (ELEMINOL MON-2) and 400 parts of ion-exchange water are added to the reactor. While being stirred, the resulting reaction solution is heated in an oil bath until the temperature of the reaction solution reaches 75° C. After 10 parts of the emulsion (19) has been added to the solution, 50 parts of an aqueous ammonium persulfate solution the concentration of which has been adjusted to 10% by mass is added to the solution. Subsequently, holding is performed for 30 minutes.

While the temperature of the reaction solution is maintained at 75° C., 390 parts of the emulsion (19) is gradually added dropwise to the reactor with a pump over 30 minutes.

Subsequent to the addition of the emulsion, the temperature of the reaction solution is changed to 80° C. After holding has been performed for 3 hours, the temperature is reduced to room temperature. Subsequently, ion-exchange water and nitric acid are added to the reactor such that the solid content concentration reaches 20% by mass. Hereby, a styrene-(meth)acrylate copolymer particle dispersion liquid (19) is prepared.

The resulting resin particles have a volume average size of 170 nm. The glass transition temperature measured with a differential scanning calorimeter is 4° C.

### Preparation of Styrene-(Meth)Acrylate Copolymer Particle Dispersion Liquid (20)

### Preparation of Emulsions (20-1) to (20-4)

### Emulsion (20-1)

Styrene: 40 parts
n-Butyl acrylate: 58.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (20-1).

### Emulsion (20-2)

Styrene: 45 parts
n-Butyl acrylate: 53.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (20-2).

### Emulsion (20-3)

Styrene: 52 parts
n-Butyl acrylate: 46.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (20-3).

### Emulsion (20-4)

Styrene: 76 parts
n-Butyl acrylate: 22.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (20-4).

A styrene-(meth)acrylate copolymer particle dispersion liquid (20) is prepared as in the preparation of the styrene-(meth)acrylate copolymer particle dispersion liquid (1), except that the emulsions (1-1), (1-2), (1-3), and (1-4) are replaced with the emulsions (20-1), (20-2), (20-3), and (20-4), respectively.

The resulting resin particles have a volume average size of 165 nm. The glass transition temperature measured with a differential scanning calorimeter is 20° C.

### Preparation of Styrene-(Meth)Acrylate Copolymer Particle Dispersion Liquid (21)

### Preparation of Emulsions (21-1) to (21-4)

### Emulsion (21-1)

Styrene: 53 parts
n-Butyl acrylate: 45.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (21-1).

### Emulsion (21-2)

Styrene: 50 parts
n-Butyl acrylate: 48.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (21-2).

### Emulsion (21-3)

Styrene: 44 parts
n-Butyl acrylate: 54.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (21-3).

### Emulsion (21-4)

Styrene: 48 parts
n-Butyl acrylate: 50.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (21-4).

A styrene-(meth)acrylate copolymer particle dispersion liquid (21) is prepared as in the preparation of the styrene-(meth)acrylate copolymer particle dispersion liquid (1), except that the emulsions (1-1), (1-2), (1-3), and (1-4) are replaced with the emulsions (21-1), (21-2), (21-3), and (21-4), respectively.

The resulting resin particles have a volume average size of 180 nm. The glass transition temperature measured with a differential scanning calorimeter is 8° C.

### Preparation of Styrene-(Meth)Acrylate Copolymer Particle Dispersion Liquid (22)

### Preparation of Emulsions (22-1) to (22-4)

### Emulsion (22-1)

Styrene: 30 parts
Ethyl acrylate: 68.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (22-1).

### Emulsion (22-2)

Styrene: 32 parts
Ethyl acrylate: 66.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (22-2).

### Emulsion (22-3)

Styrene: 34 parts
Ethyl acrylate: 64.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (22-3).

### Emulsion (22-4)

Styrene: 39 parts
Ethyl acrylate: 59.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (22-4).

A styrene-(meth)acrylate copolymer particle dispersion liquid (22) is prepared as in the preparation of the styrene-(meth)acrylate copolymer particle dispersion liquid (1), except that the emulsions (1-1), (1-2), (1-3), and (1-4) are replaced with the emulsions (22-1), (22-2), (22-3), and (22-4), respectively.

The resulting resin particles have a volume average size of 175 nm. The glass transition temperature measured with a differential scanning calorimeter is 15° C.

### Preparation of Styrene-(Meth)Acrylate Copolymer Particle Dispersion Liquid (23)

### Preparation of Emulsions (23-1) to (23-4)

### Emulsion (23-1)

Styrene: 23 parts
n-Butyl acrylate: 75.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (23-1).

### Emulsion (23-2)

Styrene: 36 parts
n-Butyl acrylate: 62.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (23-2).

### Emulsion (23-3)

Styrene: 50 parts
n-Butyl acrylate: 48.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (23-3).

### Emulsion (23-4)

Styrene: 65 parts
n-Butyl acrylate: 33.5 parts
1,10-Decanediol diacrylate: 1.5 parts
Anionic surfactant (“ELEMINOL MON-2” produced by Sanyo Chemical Industries, Ltd.): 1.2 parts
Ion-exchange water: 98.8 parts

The above materials are charged into a mixing container equipped with a stirring device and the resulting mixture is stirred to form an emulsion (23-4).

A styrene-(meth)acrylate copolymer particle dispersion liquid (23) is prepared as in the preparation of the styrene-(meth)acrylate copolymer particle dispersion liquid (1), except that the emulsions (1-1), (1-2), (1-3), and (1-4) are replaced with the emulsions (23-1), (23-2), (23-3), and (23-4), respectively.

The resulting resin particles have a volume average size of 170 nm. The glass transition temperature measured with a differential scanning calorimeter is 16° C.

### Preparation of Styrene Butadiene Rubber Particles (1)

Styrene: 48 parts
Butadiene: 50 parts
Acrylic acid: 1.9 parts
tert-Dodecanethiol: 0.1 parts
Anionic surfactant (“Dowfax2a-1” produced by The Dow Chemical Company): 1.2 parts
Ion-exchange water: 200 parts
Potassium persulfate: 1 part

The above materials are charged into a polymerization reaction container and polymerized for 2 hours at 50° C. in a nitrogen atmosphere. After the reaction has been continued for 3 hours, polymerization is terminated. Ion-exchange water is added to the resulting dispersion liquid in order to adjust the solid content concentration to 20%. Hereby, a rubber particle dispersion liquid (1) is prepared.

The resulting resin particles have a volume average size of 200 nm. The glass transition temperature measured with a differential scanning calorimeter is −24° C.

### Preparation of Amorphous Polyester Resin Dispersion Liquid (1)

Terephthalic acid: 28 molar parts
Isophthalic acid: 15 molar parts
Suberic acid: 5 molar parts
Trimellitic anhydride: 2 molar parts
Bisphenol A propylene oxide 2 mol adduct: 6 molar parts
Bisphenol A propylene oxide 3 mol adduct: 44 molar parts

The above materials are charged into a reactor equipped with a stirring device, a nitrogen introduction tube, a temperature sensor, and a fractionating column. The temperature is increased to 190° C. over 1 hour. To 100 parts of the above materials, 1.2 parts of dibutyltin oxide is added. While the product water is distilled away, the temperature is increased to 240° C. over 6 hours. While the temperature is maintained at 240° C., the dehydration condensation reaction is continued for 3 hours and then cooling is performed. Hereby, an amorphous polyester resin (1) is prepared.

The amorphous polyester resin (1) has an acid value of 11 and a glass transition temperature of 58° C.
Amorphous polyester resin (1): 100 parts
Methyl ethyl ketone: 60 parts
Isopropanol: 10 parts
10% Aqueous ammonia solution: 3.5 parts

The above materials are charged into a jacketed reaction tank equipped with a condenser, a thermometer, a water dropper, and an anchor impeller. While the liquid temperature is maintained at 50° C. with a water circulation thermostat, the amorphous polyester resin (1) is dissolved by performing stirring at 100 rpm. Then, the temperature of the water circulation thermostat is set to 40° C., and 300 parts of ion-exchange water maintained at 40° C. is added dropwise at a rate of 3 part/min in total in order to perform phase inversion. Hereby, an emulsion is prepared.

The emulsion is charged into an eggplant flask, which is connected to an evaporator equipped with a vacuum control unit with a trap ball interposed therebetween. While the eggplant flask is rotated, the temperature is increased in a hot-water bath at 60° C. With attention to bumping, the pressure is reduced to 7 kPa to remove the solvent. Subsequently, the pressure is increased to normal pressure and the eggplant flask is cooled with water. Hereby, a dispersion liquid is prepared. Jon-exchange water is added to the resulting dispersion liquid. Hereby, an amorphous polyester resin dispersion liquid (1) having a solid content of 20% by mass is prepared. The volume average size of the amorphous polyester resin particles included in the amorphous polyester resin dispersion liquid (1) is 180 nm.

### Preparation of Amorphous Polyester Resin Dispersion Liquid (2)

An amorphous polyester resin dispersion liquid (2) is prepared as in the preparation of the amorphous polyester resin dispersion liquid (1), except that the amounts of the materials charged are changed as described below.
Terephthalic acid: 34 molar parts
Isophthalic acid: 7 molar parts
Adipic acid: 7 molar parts
Trimellitic anhydride: 2 molar parts
Bisphenol A propylene oxide 2 mol adduct: 30 molar parts
Neopentyl glycol: 5 molar parts
Propylene glycol: 15 molar parts

The amorphous polyester resin (2) has an acid value of 12 and a glass transition temperature of 60° C.

The volume average size of the amorphous polyester resin particles included in the amorphous polyester resin dispersion liquid (2) is 180 nm.

### Preparation of Amorphous Polyester Resin Dispersion Liquid (3)

An amorphous polyester resin dispersion liquid (3) is prepared as in the preparation of the amorphous polyester resin dispersion liquid (1), except that the amounts of the materials charged are changed as described below.
Terephthalic acid: 40 molar parts
Isophthalic acid: 7.2 molar parts
Sebacic acid: 0.8 molar parts
Trimellitic anhydride: 2 molar parts
Bisphenol A propylene oxide 2 mol adduct: 10 molar parts
Bisphenol A propylene oxide 3 mol adduct: 40 molar parts

The amorphous polyester resin (3) has an acid value of 11 and a glass transition temperature of 61° C. The volume average size of the amorphous polyester resin particles included in the amorphous polyester resin dispersion liquid (3) is 170 nm.

### Preparation of Amorphous Polyester Resin Dispersion Liquid (4)

An amorphous polyester resin dispersion liquid (4) is prepared as in the preparation of the amorphous polyester resin dispersion liquid (1), except that the amounts of the materials charged are changed as described below.
Terephthalic acid: 35 molar parts
Isophthalic acid: 2.5 molar parts
Sebacic acid: 10.5 molar parts
Trimellitic anhydride: 2 molar parts
Bisphenol A propylene oxide 2 mol adduct: 10 molar parts
Bisphenol A propylene oxide 3 mol adduct: 40 molar parts

The amorphous polyester resin (4) has an acid value of 11 and a glass transition temperature of 55° C.

The volume average size of the amorphous polyester resin particles included in the amorphous polyester resin dispersion liquid (4) is 185 nm.

### Preparation of Amorphous Polyester Resin Dispersion Liquid (5)

An amorphous polyester resin dispersion liquid (5) is prepared as in the preparation of the amorphous polyester resin dispersion liquid (1), except that the amount of the bisphenol A propylene oxide 2 mol adduct charged is changed from 6 molar parts to 4 molar parts.

The amorphous polyester resin (5) has an acid value of 4.5 and a glass transition temperature of 58° C. The volume average size of the amorphous polyester resin particles included in the amorphous polyester resin dispersion liquid (5) is 190 nm.

### Preparation of Amorphous Polyester Resin Dispersion Liquid (6)

An amorphous polyester resin dispersion liquid (6) is prepared as in the preparation of the amorphous polyester resin dispersion liquid (1), except that the amount of the bisphenol A propylene oxide 2 mol adduct charged is changed from 6 molar parts to 8 molar parts.

The amorphous polyester resin (6) has an acid value of 4.5 and a glass transition temperature of 58° C. The volume average size of the amorphous polyester resin particles included in the amorphous polyester resin dispersion liquid (6) is 165 nm.

### Preparation of Amorphous Polyester Resin Dispersion Liquid (7)

An amorphous polyester resin dispersion liquid (7) is prepared as in the preparation of the amorphous polyester resin dispersion liquid (1), except that the amounts of the materials charged are changed as described below.
Terephthalic acid: 10 molar parts
Isophthalic acid: 31 molar parts
Sebacic acid: 7 molar parts
Trimellitic anhydride: 2 molar parts
Bisphenol A propylene oxide 2 mol adduct: 15 molar parts
Bisphenol A propylene oxide 3 mol adduct: 10 molar parts
Propylene glycol: 25 molar parts

The amorphous polyester resin (7) has an acid value of 10 and a glass transition temperature of 53° C. The volume average size of the amorphous polyester resin particles included in the amorphous polyester resin dispersion liquid (7) is 170 nm.

### Preparation of Amorphous Polyester Resin Dispersion Liquid (8)

An amorphous polyester resin dispersion liquid (8) is prepared as in the preparation of the amorphous polyester resin dispersion liquid (1), except that the amounts of the materials charged are changed as described below.
Terephthalic acid: 40 molar parts
Isophthalic acid: 2 molar parts
Sebacic acid: 4 molar parts
Trimellitic anhydride: 4 molar parts
Bisphenol A propylene oxide 2 mol adduct: 40 molar parts
Bisphenol A ethylene oxide 2 mol adduct: 10 molar parts

The amorphous polyester resin (8) has an acid value of 10 and a glass transition temperature of 73° C.

The volume average size of the amorphous polyester resin particles included in the amorphous polyester resin dispersion liquid (8) is 180 nm.

### Preparation of Amorphous Polyester Resin Dispersion Liquid (9)

An amorphous polyester resin dispersion liquid (9) is prepared as in the preparation of the amorphous polyester resin dispersion liquid (1), except that the amounts of the materials charged are changed as described below.
Terephthalic acid: 30 molar parts
Isophthalic acid: 13 molar parts
Adipic acid: 5 molar parts
Trimellitic anhydride: 2 molar parts
Bisphenol A propylene oxide 2 mol adduct: 20 molar parts
Bisphenol A ethylene oxide 2 mol adduct: 20 molar parts
Neopentyl glycol: 10 molar parts

The amorphous polyester resin (9) has an acid value of 11 and a glass transition temperature of 57° C.

The volume average size of the amorphous polyester resin particles included in the amorphous polyester resin dispersion liquid (9) is 165 nm.

### Preparation of Crystalline Polyester Resin Particle Dispersion Liquid (1)

Dodecanedioic acid: 50 molar parts
1,6-Hexanediol: 50 molar parts

The above materials are charged into a reactor equipped with a stirring device, a nitrogen introduction tube, a temperature sensor, and a fractionating column. The temperature is increased to 160° C. over 1 hour. To 100 parts of the above materials, 0.8 parts of dibutyltin oxide is added. While the product water is distilled away, the temperature is increased to 180° C. over 6 hours. While the temperature is maintained at 180° C. and stirring is performed for 5 hours, the reaction is continued in the container under reflux. Subsequently, the temperature is gradually increased to 230° C. under reduced pressure (3 kPa). While the temperature is maintained at 230° C., stirring is performed for 2 hours. Then, the reaction product is cooled. After cooling, solid-liquid separation is performed to dry the solid substance. Hereby, a crystalline polyester resin (1) is prepared. The crystalline polyester resin (1) has a weight average molecular weight of 29,000.
Crystalline polyester resin (1): 100 parts
Methyl ethyl ketone: 70 parts
Isopropanol: 12 parts
10% Aqueous ammonia solution: 3 parts

The above materials are charged into a jacketed reaction tank equipped with a condenser, a thermometer, a water dropper, and an anchor impeller. While the liquid temperature is maintained at 80° C. with a water circulation thermostat, the crystalline polyester resin (1) is dissolved by performing stirring at 100 rpm. Then, the temperature of the water circulation thermostat is set to 60° C., and 300 parts of ion-exchange water maintained at 60° C. is added dropwise at a rate of 3 part/min in total in order to perform phase inversion. Hereby, an emulsion is prepared.

The emulsion is charged into an eggplant flask, which is connected to an evaporator equipped with a vacuum control unit with a trap ball interposed therebetween. While the eggplant flask is rotated, the temperature is increased in a hot-water bath at 60° C. With attention to bumping, the pressure is reduced to 7 kPa to remove the solvent. Subsequently, the pressure is increased to normal pressure and the eggplant flask is cooled with water. Hereby, a dispersion liquid is prepared. Ion-exchange water is added to the resulting dispersion liquid. Hereby, a crystalline polyester resin particle dispersion liquid (1) having a solid content of 20% by mass is prepared. The volume average size of the crystalline polyester resin particles included in the crystalline polyester resin particle dispersion liquid (1) is 160 nm.

### Preparation of Colorant Particle Dispersion Liquid

Carbon black (“Regel330” produced by Cabot Corporation): 110 parts
Anionic surfactant (“NEOPELEX G-65” produced by Kao Corporation): 6 parts
Ion-exchange water: 300 parts

The above materials are mixed with one another, and the resulting mixture is stirred with a homogenizer (“ULTRA-TURRAX T50” produced by IKA) for 10 minutes. Ion-exchange water is added to the resulting dispersion liquid. Hereby, a colorant particle dispersion liquid having a solid content of 20% by mass is prepared. The volume average size of the colorant particles included in the colorant particle dispersion liquid is 220 nm.

### Preparation of Release Agent Particle Dispersion Liquid

Fischer-Tropsch wax (“SASOLWAX H1” produced by Sasol): 100 parts
Anionic surfactant (“NEOPELEX G-65”): 6 parts
Ion-exchange water: 300 parts

The above materials are mixed with one another, and the resulting mixture is heated to 100° C. and dispersed with a homogenizer (ULTRA-TURRAX T50). Further dispersion treatment is performed with a Manton-Gaulin high pressure homogenizer (produced by Gaulin). Ion-exchange water is added to the resulting dispersion liquid. Hereby, a release agent particle dispersion liquid having a solid content of 20% by mass is prepared.

The volume average size of the release agent particles included in the release agent particle dispersion liquid is 230 nm.

### Example 1

### Preparation of Toner 1

Amorphous polyester resin dispersion liquid (1) (solid content: 20% by mass): 28 parts
Styrene-(meth)acrylate copolymer particle dispersion liquid (1) (solid content: 20% by mass): 10 parts
Crystalline polyester resin dispersion liquid (solid content: 20% by mass): 19 parts
Colorant particle dispersion liquid (solid content: 20% by mass): 6 parts
Release agent particle dispersion liquid (solid content: 20% by mass): 8 parts
Anionic surfactant (“ELEMINOL MON-2”): 0.7 parts
Ion-exchange water: 50 parts

The above materials are charged into a reactor equipped with a thermometer, a pH meter, and a stirrer. With the temperature of the reactor being maintained at 20° C., holding is performed for 30 minutes while stirring is performed at a rotational speed of 150 rpm. Subsequently, a 0.3N aqueous nitric acid solution is added to the mixture in order to adjust the pH to 5.0. Then, while dispersion is performed with a homogenizer (ULTRA-TURRAX T50), a 2% aqueous aluminum sulfate solution is added to the mixture. Subsequently, while stirring is performed, the temperature is increased to 45° C. at a rate of 0.4° C./min and holding is performed for 30 minutes.

Then, 29 parts of the amorphous polyester resin particle dispersion liquid (1) is added to the mixture, and holding is performed for 30 minutes. Subsequently, a 0.1 N aqueous sodium hydroxide solution is added to the mixture in order to adjust the pH to 8.5. After holding has been performed for 15 minutes, while stirring is continued, the temperature is increased to 80° C. at a rate of 1° C./min and holding is performed at 80° C. for 5 hours. Then, cooling and solid-liquid separation are performed. The resulting solid substance is washed with ion-exchange water and then dried with a vacuum freeze dryer for 24 hours. Hereby, toner particles (1) having a volume average size of 5.5 μm are prepared.

With 100 parts of the toner particles (1), 2.0 parts of hydrophobic silica (“RY200” produced by Nippon Aerosil Co., Ltd.) is mixed using a Henschel Mixer. Hereby, a toner 1 is prepared.

### Examples 2 to 30 and Comparative Examples 1 to 6

### Preparation of Toners 2 to 30 and Toners C1 to C6

Toners 2 to 30 and toners C1 to C6 are prepared as in the preparation of the toner 1, except that the amounts of the materials charged are changed as described in Table 1.

TABLE 1

| | | Initially charged dispersion liquid | | | | | | | Additional | |
|---|---|---|---|---|---|---|---|---|---|---|
| | | Styrene-(meth)acrylate | | Amorphous resin | | | | Release | dispersion liquid | |
| | | copolymer resin particles | | Type of | | | Colorant | agent | Amorphous resin | |
| | | Type of resin particle | | amorphous | | Crystalline | dispersion | dispersion | Type of | |
| | | dispersion liquid (only | | polyester | | resin | liquid | liquid | amorphous | |
| Example, | | in Comparative example | Amount | resin | Amount | Amount | Amount | Amount | polyester resin | Amount |
| Comparative | | 1, styrene butadiene | added | dispersion | added | added | added | added | dispersion | added |
| example | Toner | rubber particles) | (part) | liquid | (part) | (part) | (part) | (part) | liquid | (part) |
| Example 1 | Toner 1 | 1 | 10 | 1 | 28 | 19 | 6 | 8 | 1 | 29 |
| Example 2 | Toner 2 | 2 | 10 | 1 | 28 | 19 | 6 | 8 | 1 | 29 |
| Example 3 | Toner 3 | 3 | 10 | 1 | 28 | 19 | 6 | 8 | 1 | 29 |
| Example 4 | Toner 4 | 4 | 10 | 1 | 28 | 19 | 6 | 8 | 1 | 29 |
| Example 5 | Toner 5 | 5 | 10 | 1 | 28 | 19 | 6 | 8 | 1 | 29 |
| Example 6 | Toner 6 | 6 | 10 | 1 | 28 | 19 | 6 | 8 | 1 | 29 |
| Example 7 | Toner 7 | 7 | 10 | 1 | 28 | 19 | 6 | 8 | 1 | 29 |
| Example 8 | Toner 8 | 8 | 10 | 1 | 28 | 19 | 6 | 8 | 1 | 29 |
| Example 9 | Toner 9 | 9 | 10 | 1 | 28 | 19 | 6 | 8 | 1 | 29 |
| Example 10 | Toner 10 | 10 | 10 | 2 | 28 | 19 | 6 | 8 | 2 | 29 |
| Example 11 | Toner 11 | 11 | 10 | 2 | 28 | 19 | 6 | 8 | 2 | 29 |
| Example 12 | Toner 12 | 12 | 10 | 1 | 28 | 19 | 6 | 8 | 1 | 29 |
| Example 13 | Toner 13 | 13 | 10 | 1 | 28 | 19 | 6 | 8 | 1 | 29 |
| Example 14 | Toner 14 | 14 | 10 | 2 | 28 | 19 | 6 | 8 | 2 | 29 |
| Example 15 | Toner 15 | 1 | 1.5 | 1 | 42.5 | 13 | 6 | 8 | 1 | 29 |
| Example 16 | Toner 16 | 1 | 21 | 1 | 21 | 15 | 6 | 8 | 1 | 29 |
| Example 17 | Toner 17 | 15 | 10 | 1 | 28 | 19 | 6 | 8 | 1 | 29 |
| Example 18 | Toner 18 | 16 | 10 | 1 | 28 | 19 | 6 | 8 | 1 | 29 |
| Example 19 | Toner 19 | 17 | 10 | 1 | 28 | 19 | 6 | 8 | 1 | 29 |
| Example 20 | Toner 20 | 1 | 10 | 3 | 28 | 19 | 6 | 8 | 3 | 29 |
| Example 21 | Toner 21 | 1 | 10 | 4 | 28 | 19 | 6 | 8 | 4 | 29 |
| Example 22 | Toner 22 | 1 | 10 | 5 | 28 | 19 | 6 | 8 | 5 | 29 |
| Example 23 | Toner 23 | 1 | 10 | 6 | 28 | 19 | 6 | 8 | 6 | 29 |
| Example 24 | Toner 24 | 8 | 10 | 7 | 28 | 19 | 6 | 8 | 7 | 29 |
| Example 25 | Toner 25 | 18 | 10 | 8 | 28 | 19 | 6 | 8 | 8 | 29 |
| Example 26 | Toner 26 | 1 | 10 | 9 | 28 | 19 | 6 | 8 | 9 | 29 |
| Example 27 | Toner 27 | 1 | 10.5 | 1 | 36 | 10.5 | 6 | 8 | 1 | 29 |
| Example 28 | Toner 28 | 1 | 11 | 1 | 15.5 | 30.5 | 6 | 8 | 1 | 29 |
| Example 29 | Toner 29 | 1 | 3.5 | 1 | 35 | 18.5 | 6 | 8 | 1 | 29 |
| Example 30 | Toner 30 | 1 | 23 | 1 | 23 | 11 | 6 | 8 | 1 | 29 |
| Comparative | Toner C1 | Rubber | 10 | 1 | 28 | 19 | 6 | 8 | 1 | 29 |
| example 1 | | particles 1 | | | | | | | | |
| Comparative | Toner C2 | 19 | 10 | 1 | 28 | 19 | 6 | 8 | 1 | 29 |
| example 2 | | | | | | | | | | |
| Comparative | Toner C3 | 20 | 10 | 1 | 28 | 19 | 6 | 8 | 1 | 29 |
| example 3 | | | | | | | | | | |
| Comparative | Toner C4 | 21 | 10 | 1 | 28 | 19 | 6 | 8 | 1 | 29 |
| example 4 | | | | | | | | | | |
| Comparative | Toner C5 | 22 | 10 | 2 | 28 | 19 | 6 | 8 | 2 | 29 |
| example 5 | | | | | | | | | | |
| Comparative | Toner C6 | 23 | 10 | 1 | 28 | 19 | 6 | 8 | 1 | 29 |
| example 6 | | | | | | | | | | |

The following values of each of the toners prepared in Examples 1 to 30 and Comparative Examples 1 to 6 are determined. Table 2 lists the items related to styrene-(meth)acrylate copolymer resin particles. Table 3 lists the items related to the amorphous and crystalline resins. All of the above items are measured in accordance with the above-described methods or commonly used methods.

### Items Related to Styrene-(Meth)Acrylate Copolymer Resin Particles

Note that, in Comparative Example 1, a styrene butadiene rubber particle dispersion liquid is used as a resin particle dispersion liquid. In the column of Comparative Example 1, the symbol “-” means the value does not exist.
Measured glass transition temperature Tg(E)° C.
Tg(E)−Tg(C1) (glass transition temperature calculated using a Fox equation on the basis of the proportions of monomers constituting resin particles)
Tg(C1)−Tg(C2) (glass transition temperature calculated using a Fox equation on the basis of the monomer proportions determined by surface analysis of resin particles)
Ws(S): Proportion calculated from styrene determined by surface analysis
Ws(S)−Ws(B) (Proportion calculated from styrene included in the entire resin particles)
Content of resin particles in toner
Average equivalent circle diameter of domain: referred to as “Domain equivalent circle diameter”
Average shape factor SF-1 of domain: referred to as “Domain SF-1”

### Items Related to Amorphous Resin

Proportion of aliphatic dicarboxylic acid in acid monomer
Acid value
Tg(ap) (measured glass transition temperature of amorphous resin)−Tg(C1) (glass transition temperature calculated from the proportions of monomers constituting the entire resin particles)
   |SP(1)-SP(2)|: both are SP values calculated using a Fedors method: SP(1) is the SP value of binder resin, while SP(2) is the SP value calculated from the monomer composition determined by the surface analysis of resin particles.

### Items Related to Crystalline Resin

Proportion in binder resin
w1 (Content of resin particles in toner)/w2 (Content of crystalline resin in toner)

TABLE 2

| | Styrene-(meth)acrylate copolymer resin particles | | | | | | | | |
|---|---|---|---|---|---|---|---|---|---|
| | Type of | | | | | | | Domain | |
| | resin | | | | | | | equivalent | |
| Example, | particle | | Tg(E) − | Tg(C2) − | | Ws(S) − | Content | circle | |
| Comparative | dispersion | Tg(E) | Tg(C1) | Tg(C1) | Ws(S) | Ws(B) | in toner | diameter | Domain |
| example | liquid | ° C. | (° C.) | (° C.) | (mol %) | (mol %) | (mass %) | (nm) | SF-1 |
| Example 1 | 1 | 17 | 14 | 16 | 66 | 10 | 10 | 165 | 113 |
| Example 2 | 2 | 9 | 6 | 5 | 59 | 3 | 10 | 160 | 114 |
| Example 3 | 3 | 12 | 9 | 5 | 59 | 3 | 10 | 165 | 115 |
| Example 4 | 4 | 20 | 17 | 16 | 66 | 10 | 10 | 170 | 118 |
| Example 5 | 5 | 22 | 19 | 16 | 66 | 10 | 10 | 175 | 119 |
| Example 6 | 6 | 15 | 13 | 5 | 59 | 4 | 10 | 180 | 118 |
| Example 7 | 7 | 7 | 6 | 1 | 58 | 1 | 10 | 170 | 120 |
| Example 8 | 8 | 22 | 8 | 6 | 41 | 6 | 10 | 165 | 114 |
| Example 9 | 9 | 25 | 11 | 11 | 46 | 10 | 10 | 160 | 112 |
| Example 10 | 10 | 9 | 11 | 11 | 74 | 6 | 10 | 155 | 113 |
| Example 11 | 11 | 14 | 13 | 20 | 79 | 9 | 10 | 175 | 116 |
| Example 12 | 12 | 19 | 16 | 33 | 75 | 19 | 10 | 170 | 114 |
| Example 13 | 13 | −1 | 15 | 11 | 66 | 5 | 10 | 175 | 121 |
| Example 14 | 14 | 31 | 15 | 11 | 48 | 8 | 10 | 170 | 113 |
| Example 15 | 1 | 17 | 14 | 16 | 66 | 10 | 1.5 | 165 | 113 |
| Example 16 | 1 | 17 | 14 | 16 | 66 | 10 | 21 | 165 | 113 |
| Example 17 | 15 | 17 | 14 | 16 | 66 | 10 | 10 | 45 | 110 |
| Example 18 | 16 | 17 | 14 | 16 | 66 | 10 | 10 | 310 | 124 |
| Example 19 | 17 | 17 | 14 | 15 | 66 | 10 | 10 | 195 | 131 |
| Example 20 | 1 | 17 | 14 | 16 | 66 | 10 | 10 | 165 | 113 |
| Example 21 | 1 | 17 | 14 | 16 | 66 | 10 | 10 | 165 | 113 |
| Example 22 | 1 | 17 | 14 | 16 | 66 | 10 | 10 | 165 | 113 |
| Example 23 | 1 | 17 | 14 | 16 | 66 | 10 | 10 | 165 | 113 |
| Example 24 | 8 | 22 | 8 | 6 | 41 | 6 | 10 | 165 | 114 |
| Example 25 | 18 | 1 | 19 | 17 | 69 | 10 | 10 | 160 | 112 |
| Example 26 | 1 | 17 | 14 | 16 | 66 | 10 | 10 | 165 | 113 |
| Example 27 | 1 | 17 | 14 | 16 | 66 | 10 | 10 | 165 | 113 |
| Example 28 | 1 | 17 | 14 | 16 | 66 | 10 | 11 | 165 | 113 |
| Example 29 | 1 | 17 | 14 | 16 | 66 | 10 | 3.5 | 165 | 113 |
| Example 30 | 1 | 17 | 14 | 16 | 66 | 10 | 23 | 165 | 113 |
| Comparative | Rubber | −24 | 1 | 0 | — | — | 10 | 200 | 120 |
| example 1 | particles 1 | | | | | | | | |
| Comparative | 19 | 4 | 1 | 0 | 56 | 0 | 10 | 170 | 116 |
| example 2 | | | | | | | | | |
| Comparative | 20 | 20 | 21 | 51 | 81 | 22 | 10 | 165 | 116 |
| example 3 | | | | | | | | | |
| Comparative | 21 | 8 | 7 | −1 | 54 | −1 | 10 | 180 | 118 |
| example 4 | | | | | | | | | |
| Comparative | 22 | 15 | 4 | 6 | 39 | 5 | 10 | 175 | 119 |
| example 5 | | | | | | | | | |
| Comparative | 23 | 16 | 22 | 33 | 71 | 21 | 10 | 170 | 115 |
| example 6 | | | | | | | | | |

TABLE 3

| | Amorphous polyester resin | | | | | | | | |
|---|---|---|---|---|---|---|---|---|---|
| | Type of | Proportion | | | | Crystalline resin | | | |
| | resin | of aliphatic | | | | Proportion | | Evaluations | |
| Example, | particle | dicarboxylic | | Tg(ap) − | | in binder | | | Low |
| Comparative | dispersion | acid | Acid value | Tg(C1) | \|SP(1) − | resin | | | temperature |
| example | liquid | (mol %) | (mgKOH/g) | (° C.) | SP(2)\| | (mass %) | w1/w2 | Adhesion | fixability |
| Example 1 | 1 | 10 | 11 | 55 | 0.24 | 25 | 0.53 | A | A |
| Example 2 | 1 | 10 | 11 | 55 | 0.19 | 25 | 0.53 | C | B |
| Example 3 | 1 | 10 | 11 | 55 | 1.19 | 25 | 0.53 | B | A |
| Example 4 | 1 | 10 | 11 | 55 | 0.24 | 25 | 0.53 | A | B |
| Example 5 | 1 | 10 | 11 | 55 | 0.24 | 25 | 0.53 | B | C |
| Example 6 | 1 | 10 | 11 | 55 | 0.19 | 25 | 0.53 | A | A |
| Example 7 | 1 | 10 | 11 | 54 | 0.18 | 25 | 0.53 | C | B |
| Example 8 | 1 | 10 | 11 | 44 | 0.32 | 25 | 0.53 | C | B |
| Example 9 | 1 | 10 | 11 | 44 | 0.34 | 25 | 0.53 | B | A |
| Example 10 | 2 | 14 | 12 | 62 | 0.26 | 25 | 0.53 | A | B |
| Example 11 | 2 | 14 | 12 | 59 | 0.19 | 25 | 0.53 | B | C |
| Example 12 | 1 | 10 | 11 | 55 | 0.31 | 25 | 0.53 | B | C |
| Example 13 | 1 | 10 | 11 | 72 | 0.25 | 25 | 0.53 | C | C |
| Example 14 | 2 | 14 | 12 | 41 | 0.19 | 25 | 0.53 | C | C |
| Example 15 | 1 | 10 | 11 | 55 | 0.18 | 15 | 0.12 | C | C |
| Example 16 | 1 | 10 | 11 | 55 | 0.23 | 23 | 1.4 | B | C |
| Example 17 | 1 | 10 | 11 | 55 | 0.24 | 25 | 0.53 | C | B |
| Example 18 | 1 | 10 | 11 | 55 | 0.24 | 25 | 0.53 | B | C |
| Example 19 | 1 | 10 | 11 | 55 | 0.24 | 25 | 0.53 | C | B |
| Example 20 | 3 | 1.6 | 11 | 58 | 0.19 | 25 | 0.53 | C | A |
| Example 21 | 4 | 21 | 11 | 52 | 0.29 | 25 | 0.53 | C | B |
| Example 22 | 5 | 10 | 4.5 | 55 | 0.22 | 25 | 0.53 | C | B |
| Example 23 | 6 | 10 | 21 | 55 | 0.25 | 25 | 0.53 | C | B |
| Example 24 | 7 | 14 | 10 | 39 | 0.19 | 25 | 0.53 | C | C |
| Example 25 | 8 | 8 | 10 | 91 | 0.33 | 25 | 0.53 | C | B |
| Example 26 | 9 | 10 | 11 | 54 | 0.14 | 25 | 0.53 | C | B |
| Example 27 | 1 | 10 | 11 | 55 | 0.17 | 14 | 1 | B | C |
| Example 28 | 1 | 10 | 11 | 55 | 0.32 | 41 | 0.36 | C | A |
| Example 29 | 1 | 10 | 11 | 55 | 0.22 | 22 | 0.19 | C | A |
| Example 30 | 1 | 10 | 11 | 55 | 0.19 | 17 | 2.1 | B | C |
| Comparative | 1 | 10 | 11 | 83 | 0.74 | 25 | 0.53 | D | D |
| example 1 | | | | | | | | | |
| Comparative | 1 | 10 | 11 | 55 | 0.17 | 25 | 0.53 | D | B |
| example 2 | | | | | | | | | |
| Comparative | 1 | 10 | 11 | 59 | 0.37 | 25 | 0.53 | B | D |
| example 3 | | | | | | | | | |
| Comparative | 1 | 10 | 11 | 57 | 0.16 | 25 | 0.53 | D | B |
| example 4 | | | | | | | | | |
| Comparative | 2 | 14 | 12 | 49 | 0.26 | 25 | 0.53 | D | B |
| example 5 | | | | | | | | | |
| Comparative | 1 | 10 | 11 | 67 | 0.12 | 25 | 0.53 | B | D |
| example 6 | | | | | | | | | |

### Preparation of Developers

Developers are each prepared by mixing 8 parts of one of the toners with 92 parts of the carrier described below. The developers are used in the evaluations described below.

### Preparation of Carrier

Ferrite particles (average particle size: 35 m): 100 parts
Toluene: 14 parts
Styrene/methyl methacrylate copolymer (copolymerization ratio: 15/85): 3 parts
Carbon black: 0.2 parts

The above components except the ferrite particles are dispersed with a sand mill to form a dispersion liquid. The dispersion liquid and the ferrite particles are charged into a degassing vacuum kneader. Then, while stirring is performed, the pressure is reduced and drying is performed. Hereby, a carrier is prepared.

### Evaluations

### Adhesion of Image

A solid image is continuously formed on both surfaces of normal 500 A4-size paper sheets (“JD COAT 104” produced by FUJIFILM Business Innovation Corp.) using one of the toners prepared in Examples and Comparative Examples with a modification of a monochrome printer “Revoria Press E1136”. With the images being stacked on top of one another, the printed paper sheets are stored in a constant-temperature high-humidity vessel having a temperature of 55° C. and a humidity of 40% for 1 hour.

The print samples are taken from the constant-temperature high-humidity vessel and detached from one another. Whether the images are adhered to one another is determined visually.

The evaluation criteria are as described below. Table 3 lists the results.
A: Adhesion is not confirmed.
B: Slight adhesion that can be barely identified visually is confirmed, but it is negligible and within an acceptable range.
C: Adhesion that can be identified visually is confirmed and a stain is clearly present, but it is within an acceptable range.
D: A part of the image is clearly missed due to adhesion, and it is at unacceptable level.

### Low Temperature Fixability of Image

A 50% halftone image is formed on A4-size waterproof white films (produced by FUJIFILM Business Innovation Corp.) using one of the toners prepared in Examples and Comparative Examples with a modification of a monochrome printer “Revoria Press E1136” (produced by FUJIFILM Business Innovation Corp.) at 10° C.

The level of fixation of the image is determined by a tape stripping method. The evaluation criteria are as described below. Table 3 lists the results.
A: Defects, such as missing image and streaks, are totally absent.
B: Some parts of the image are missed, but it is negligible and within an acceptable range.
C: Parts of the image are clearly missed, but it is within an acceptable range.
D: Missing parts and streaks are clearly present in the image, and it is at unacceptable level.

As described in Table 3, it is confirmed that the electrostatic image developing toners prepared in Examples enable a reduction in the adhesion of images to one another and have low temperature fixability, compared with the electrostatic image developing toners prepared in Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An electrostatic image developing toner comprising:
a binder resin; and
resin particles,
the binder resin including an amorphous resin and a crystalline resin,
the resin particles including a styrene-(meth)acrylate copolymer,
wherein, when a glass transition temperature calculated using a Fox equation on the basis of proportions of monomers constituting the entire resin particles is defined as Tg(C1)° C. and a glass transition temperature measured using a differential scanning calorimeter is defined as Tg(E)° C.,

$$5.0 \leq Tg ( E ) - Tg ( C 1 ) \leq 20.0 ,$$

and
when a glass transition temperature calculated using a Fox equation on the basis of monomer proportions determined by surface analysis of the resin particles is defined as Tg(C2)° C.,

$$Tg ( C 1 ) < Tg ( C 2 ) . \qquad ( ( ( 2 ) ) )$$

(((2)))

An electrostatic image developing toner comprising:
a binder resin; and
resin particles,
the binder resin including an amorphous resin and a crystalline resin,
the resin particles including a styrene-(meth)acrylate copolymer,
wherein, when a proportion of a unit derived from a styrene monomer included in the resin particles is defined as Ws(B) mol % and a proportion of the unit derived from a styrene monomer, the proportion being determined by surface analysis of the resin particles, is defined as Ws(S) mol %,
Ws(S) is 40 mol % or more and 80 mol % or less, and

$$2 \leq Ws ( S ) - Ws ( B ) \leq 20. \qquad ( ( ( 3 ) ) )$$

The electrostatic image developing toner according to (((1))) or (((2))),
wherein the Tg(E) is 0° C. or more and 30° C. or less.
   (((4)))

The electrostatic image developing toner according to (((1))) or (((3))),
wherein the resin particles are crosslinked particles.
   (((5)))

The electrostatic image developing toner according to any one of (((1))) to (((4))),
wherein, in production of the resin particles, when the styrene-(meth)acrylate copolymer is produced by polymerization of a monomer-containing liquid including styrene and (meth)acrylate, a ratio of a content of the styrene in the monomer-containing liquid to a content of the (meth)acrylate in the monomer-containing liquid is increased with progress of polymerization.
   (((6)))

The electrostatic image developing toner according to any one of (((1))) to (((5))),
wherein a proportion of the crystalline resin in the binder resin is 15% by mass or more and 40% by mass or less.
   (((7)))

The electrostatic image developing toner according to any one of (((1))) to (((6))),
wherein a content of the resin particles is 2% by mass or more and 20% by mass or less.
   (((8)))

The electrostatic image developing toner according to any one of (((1))) to (((7))),
wherein a ratio w1/w2 of a content w1 of the resin particles in the toner to a content w2 of the crystalline resin in the toner is 0.2 or more and 2.0 or less.
   (((9)))

The electrostatic image developing toner according to any one of (((1))) to (((8))),
wherein the amorphous resin includes an amorphous polyester resin, and
the crystalline resin includes a crystalline polyester resin.
   (((10)))

The electrostatic image developing toner according to (((9))),
wherein the amorphous polyester resin includes a unit derived from an aliphatic dicarboxylic acid, and
a proportion of the unit derived from an aliphatic dicarboxylic acid to a unit derived from an acid component monomer included in the amorphous polyester resin is 2 mol % or more and 20 mol % or less.
   (((11)))

The electrostatic image developing toner according to (((9))) or (((10))),
wherein an acid value of the amorphous polyester resin is 5 mgKOH/g or more and 20 mgKOH/g or less.
   (((12)))

The electrostatic image developing toner according to any one of (((9))) to (((11))),
wherein, when a glass transition temperature of the amorphous polyester resin, the glass transition temperature being measured using a differential scanning calorimeter, is defined as Tg(ap)° C.,

$$40 \leq Tg ( ap ) - Tg ( C 1 ) \leq 90. \qquad ( ( ( 13 ) ) )$$

The electrostatic image developing toner according to any one of (((1))) to(((12))),
wherein, when an SP value of the binder resin, the SP value being calculated by a Fedors method is defined as SP(1) and an SP value calculated using a Fedors method on the basis of a monomer composition determined by surface analysis of the resin particles is defined as SP(2),

$$\vert SP ( 1 ) - SP ( 2 ) \vert \geq 0.15 \qquad ( ( ( 14 ) ) )$$

The electrostatic image developing toner according to any one of (((1))) to (((13))),
wherein an average equivalent circle diameter of domains formed by the resin particles is 50 nm or more and 300 nm or less.
   (((15)))

The electrostatic image developing toner according to any one of (((1))) to (((14))),
wherein an average shape factor SF-1 of domains formed by the resin particles is 130 or less.
   (((16)))

The electrostatic image developing toner according to (((2)),
wherein the resin particles are crosslinked particles.
   (((17)))

The electrostatic image developing toner according to (((2))) or (((16))),
wherein the amorphous resin includes an amorphous polyester resin, and
when a glass transition temperature of the amorphous polyester resin, the glass transition temperature being measured using a differential scanning calorimeter, is defined as Tg(ap)° C. and a glass transition temperature calculated using a Fox equation on the basis of proportions of monomers constituting the entire resin particles is defined as Tg(C1)° C.,

$$40 \leq Tg ( ap ) - Tg ( C 1 ) \leq 90. \qquad ( ( ( 18 ) ) )$$

An electrostatic image developer comprising:
the electrostatic image developing toner according to any one of (((1))) to (((17))).
   (((19)))

A toner cartridge detachably attachable to an image forming apparatus, the toner cartridge comprising:
the electrostatic image developing toner according to any one of (((1))) to (((17))).
   (((20)))

An image forming apparatus comprising:
an image holding member;
a charging unit that charges a surface of the image holding member;
an electrostatic image formation unit that forms an electrostatic image on the charged surface of the image holding member;
a developing unit that includes the electrostatic image developer according to (((18))) and develops the electrostatic image formed on the surface of the image holding member with the electrostatic image developer to form a toner image;
a transfer unit that transfers the toner image formed on the surface of the image holding member onto a surface of a recording medium; and
a fixing unit that fixes the toner image transferred on the surface of the recording medium.

What is claimed is:

1. An electrostatic image developing toner comprising:
a binder resin; and
resin particles,
the binder resin including an amorphous resin and a crystalline resin,
the resin particles including a styrene-(meth)acrylate copolymer,
wherein, when a glass transition temperature calculated using a Fox equation on the basis of proportions of monomers constituting the entire resin particles is defined as Tg(C1)° C. and a glass transition temperature measured using a differential scanning calorimeter is defined as Tg(E)° C.,
$$5.0 \leq Tg ( E ) - Tg ( C 1 ) \leq 20.0 ,$$
and
when a glass transition temperature calculated using a Fox equation on the basis of monomer proportions determined by surface analysis of the resin particles is defined as Tg(C2)° C.,
$$Tg ( C 1 ) < Tg ( C 2 ) .$$

2. An electrostatic image developing toner comprising:
a binder resin; and
resin particles,
the binder resin including an amorphous resin and a crystalline resin,
the resin particles including a styrene-(meth)acrylate copolymer,
wherein, when a proportion of a unit derived from a styrene monomer included in the resin particles is defined as Ws(B) mol % and a proportion of the unit derived from a styrene monomer, the proportion being determined by surface analysis of the resin particles, is defined as Ws(S) mol %,
Ws(S) is 40 mol % or more and 80 mol % or less, and
$$2 \leq Ws ( S ) - Ws ( B ) \leq 20.$$

3. The electrostatic image developing toner according to claim 1,
wherein the Tg(E) is 0° C. or more and 30° C. or less.

4. The electrostatic image developing toner according to claim 1,
wherein the resin particles are crosslinked particles.

5. The electrostatic image developing toner according to claim 1,
wherein, in production of the resin particles, when the styrene-(meth)acrylate copolymer is produced by polymerization of a monomer-containing liquid including styrene and (meth)acrylate, a ratio of a content of the styrene in the monomer-containing liquid to a content of the (meth)acrylate in the monomer-containing liquid is increased with progress of polymerization.

6. The electrostatic image developing toner according to claim 1,
wherein a proportion of the crystalline resin in the binder resin is 15% by mass or more and 40% by mass or less.

7. The electrostatic image developing toner according to claim 1,
wherein a content of the resin particles is 2% by mass or more and 20% by mass or less.

8. The electrostatic image developing toner according to claim 1,
wherein a ratio w1/w2 of a content w1 of the resin particles in the toner to a content w2 of the crystalline resin in the toner is 0.2 or more and 2.0 or less.

9. The electrostatic image developing toner according to claim 1,
wherein the amorphous resin includes an amorphous polyester resin, and
the crystalline resin includes a crystalline polyester resin.

10. The electrostatic image developing toner according to claim 9,
wherein the amorphous polyester resin includes a unit derived from an aliphatic dicarboxylic acid, and
a proportion of the unit derived from an aliphatic dicarboxylic acid to a unit derived from an acid component monomer included in the amorphous polyester resin is 2 mol % or more and 20 mol % or less.

11. The electrostatic image developing toner according to claim 9,
wherein an acid value of the amorphous polyester resin is 5 mgKOH/g or more and 20 mgKOH/g or less.

12. The electrostatic image developing toner according to claim 9,
wherein, when a glass transition temperature of the amorphous polyester resin, the glass transition temperature being measured using a differential scanning calorimeter, is defined as Tg(ap)° C.,
$$40 \leq Tg ( ap ) - Tg ( C 1 ) \leq 90.$$

13. The electrostatic image developing toner according to claim 2,
wherein, when an SP value of the binder resin, the SP value being calculated by a Fedors method, is defined as SP(1) and an SP value calculated using a Fedors method on the basis of a monomer composition determined by surface analysis of the resin particles is defined as SP(2),
$$\vert SP ( 1 ) - SP ( 2 ) \vert \geq 0.15 .$$

14. The electrostatic image developing toner according to claim 1,
wherein an average equivalent circle diameter of domains formed by the resin particles is 50 nm or more and 300 nm or less.

15. The electrostatic image developing toner according to claim 1,
wherein an average shape factor SF-1 of domains formed by the resin particles is 130 or less.

16. The electrostatic image developing toner according to claim 2,
wherein the resin particles are crosslinked particles.

17. The electrostatic image developing toner according to claim 2,
wherein the amorphous resin includes an amorphous polyester resin, and
when a glass transition temperature of the amorphous polyester resin, the glass transition temperature being measured using a differential scanning calorimeter, is defined as Tg(ap)° C. and a glass transition temperature calculated using a Fox equation on the basis of proportions of monomers constituting the entire resin particles is defined as Tg(C1)° C.,
$$40 \leq Tg ( ap ) - Tg ( C 1 ) \leq 90.$$

18. An electrostatic image developer comprising:
the electrostatic image developing toner according to claim 1.

19. A toner cartridge detachably attachable to an image forming apparatus, the toner cartridge comprising:
the electrostatic image developing toner according to claim 1.

20. An image forming apparatus comprising:
an image holding member;
a charging unit that charges a surface of the image holding member;
an electrostatic image formation unit that forms an electrostatic image on the charged surface of the image holding member;
a developing unit that includes the electrostatic image developer according to claim 18 and develops the electrostatic image formed on the surface of the image holding member with the electrostatic image developer to form a toner image;
a transfer unit that transfers the toner image formed on the surface of the image holding member onto a surface of a recording medium; and
a fixing unit that fixes the toner image transferred on the surface of the recording medium.
